(19) United States
(12) Patent Application Publication
(10) Pub. No.: US 2023/0079847 A1
(43) Pub. Date: Mar. 16, 2023

(54) BRAIN-LIKE VISUAL NEURAL NETWORK WITH FORWARD-LEARNING AND META-LEARNING FUNCTIONS

(71) Applicant: NEUROCEAN TECHNOLOGIES INC., Shenzhen (CN)

(72) Inventor: Hualong REN, Shenzhen (CN)

(21) Appl. No.: 17/991,143

(22) Filed: Nov. 21, 2022

Related U.S. Application Data
(63) Continuation-in-part of application No. PCT/CN2021/093354, filed on May 12, 2021.

(30) Foreign Application Priority Data
May 19, 2020 (CN) 202010424999.8

(51) Int. Cl. G06N 3/08; G06N 3/04; G06N 3/063

(52) U.S. Cl. CPC G06N 3/08; G06N 3/04; G06N 3/063

(57) ABSTRACT

A brain-like visual neural network with forward-learning and meta-learning functions is provided, comprising the primary feature encoding module, the composite feature encoding module, comprising the active attention mechanism and automatic attention mechanism, having neural loops that explicitly encode the location information of visual features, having forward neural pathways and reverse neural pathways, supporting upper and lower bi-directional information processing, adopting a variety of plasticity process with biological rationality, with the ability to conduct forward-learning to fast encode the visual representation of the input image or video information to memory information, and to conduct information abstraction process and information component adjustment process to obtain the common feature information and different feature information between objects, forming information channels with multiple information dimensions and information abstraction degrees, improving generalization ability while retaining detailed information.

### CROSS-REFERENCE TO RELATED APPLICATIONS

This application is a continuation-in-part application of PCT International Application No. PCT/CN2021/093354 filed on May 12, 2021, which claims the priority to and benefits of Chinese Patent Application No. 202010424999.8 filed on May 19, 2020. The entire contents of the above applications are incorporated herein by reference for all purposes.

### FIELD

The invention relates to the field of brain-like vision algorithms and impulse neural networks, and more specifically to a brain-like visual neural network with forward-learning and meta-learning functions.

### BACKGROUND

The existing deep learning vision algorithms have the following problems:

1. The lack of explicit encoding of the position of visual features makes it difficult to describe the position composition relationship between features flexibly, which is not conducive to encoding and recognizing rich and accurate shapes and contours, as well as describing the shape and position relationship between objects.

2. The end-to-end training paradigm relying on error back-propagation and gradient descent involves a large number of partial differential operations, which has high training cost and is difficult to break through the Von Neumann architecture.

3. They lack the mechanism of combining and abstracting multiple dimensions of information, and it is difficult to form information channels with multiple dimensions and information abstraction levels.

4. They only have the forward neural pathway, lack reverse neural pathway, thus cannot support the top-down information processing process.

5. They do not have the function of forward-learning, and it is not easy to quickly remember the input pictures or video streams, which also leads to a large amount of data required for training and a long training cycle.

The visual nervous system of the biological brain provides an excellent reference blueprint for designing brain-like visual neural networks. According to the neural circuits and working principles of biological visual nervous system, brain-like visual neural network should include at least two position encoding methods: Implicit Position Encoding and Explicit Position Encoding. The Implicit Position Encoding is that, through the corresponding connection step by step from the images to the neurons in each layer, the neurons encoding the features in each layer have corresponding receptive fields, instead of using a special neural loop to encode the position information. This Implicit Position Encoding method is not flexible enough, it cannot flexibly combine each visual feature at any position, and it cannot combine, abstract and process the information according to the position information, so the generalization ability of recognition is weak. The Explicit Position Encoding, using specialized neural circuits to encode the location information, can flexibly combine various visual features in any position, also can combine, abstract and process the position information, can encode more abundant shape and position relationship, has strong generalization ability of recognition, and can also accurately identify the situation with strong shape and position relationship constraints.

The biological visual nervous system also has bottom-up and top-down bidirectional neural pathways, which have priming effect and can help the visual search process. The brain-like visual neural networks should also learn from this feature.

The biological visual nervous system has a variety of learning paradigms, such as reinforcement learning, forward-learning and meta-learning, with plasticity mechanism as the core. If the brain-like visual neural network adopts a biologically inspired plasticity mechanism, it can get rid of the training paradigm of error back-propagation and gradient descent, avoid a large number of partial differential operations, and is expected to break through the Von Neumann architecture, which is more suitable for deployment in firmware or neuromorphic chips. In addition, the brain-like visual neural network should also have the function of forward-learning and meta-learning, which can quickly learn and encode the visual features of the seen pictures or video streams, carry out information abstraction, find the common representation between objects, make the generalization ability better, reduce the data required for training, and shorten the training period.

### SUMMARY

One of the purposes of this application is to provide a brain-like visual neural network with forward-learning and meta-learning functions, which is designed to solve the problems that the existing machine vision neural network cannot be compatible with multiple learning paradigms at the same time, the generalization ability is poor, the training process needs a large number of partial differential operations, and the training cycle is long.

In order to achieve the above objectives, the present invention adopts the following technical solutions.

The present application provides a brain-like visual neural network with forward-learning and meta-learning functions, comprising: a plurality of primary feature encoding modules and a plurality of composite feature encoding modules.

The primary feature encoding modules and the composite feature encoding modules each comprises a plurality of neurons.

The plurality of the neurons comprises primary feature encoding neuron, concrete feature encoding neuron, and abstract feature encoding neuron.

Each primary feature encoding module comprises a plurality of the primary feature encoding neurons for encoding primary visual feature information.

Each composite feature encoding module comprises a concrete feature encoding unit and an abstract feature encoding unit.

The concrete feature encoding unit comprises a plurality of the concrete feature encoding neurons for encoding concrete visual feature information.

The abstract feature encoding unit comprises a plurality of the abstract feature encoding neurons for encoding abstract visual feature information.

In the expression, if unidirectional connections are formed between neuron A and neuron B, it means unidirectional connections of A->B, if bidirectional connections are formed between neuron A and neuron B, it means A<->B (or A->B and A<-B) bidirectional connections.

If there is an A->B unidirectional connection between neuron A and neuron B, then neuron A is called the direct upstream neuron of neuron B, and neuron B is called the direct downstream neuron of neuron A, if a bidirectional connection of A<->B between neuron A and neuron B, then neuron A and neuron B are direct upstream neurons and direct downstream neurons.

If there is no connection between neuron A and neuron B, but they are connected by one or more other neurons, such as A->C-> . . . ->D->B, then neuron A is called the indirect upstream neuron of neuron B, neuron B is called the indirect downstream neuron of neuron A, and neuron D is called the direct upstream neuron of neuron B.

The excitatory connection is: when the upstream neurons of the excitatory connection activate, non-negative input is provided to the downstream neurons through the excitatory connection.

The inhibitory connection is: when the upstream neurons of the inhibitory connection activate, non-positive input is provided to the downstream neurons through the inhibitory connection.

A plurality of the primary feature encoding neurons respectively form unidirectional or bidirectional excitatory/inhibitory connections with a plurality of other said primary feature encoding neurons.

A plurality of the primary feature encoding neurons and a plurality of the concrete feature encoding neurons or a plurality of the abstract feature encoding neurons located in at least one of the composite feature encoding modules respectively form the unidirectional or bidirectional excitatory/inhibitory connections.

A plurality of the concrete feature encoding neurons located in a same composite feature encoding module and a plurality of the abstract feature encoding neurons located in the same composite feature encoding module respectively form the unidirectional or bidirectional excitatory/inhibitory connections.

A plurality of the concrete feature encoding neurons and the abstract feature encoding neurons in a plurality of the composite feature encoding modules respectively form the unidirectional or bidirectional excitatory/inhibitory connections with a plurality of the concrete feature encoding neurons and the abstract feature encoding neurons of a plurality of other composite feature encoding modules.

The brain-like visual neural network buffers and encodes information through firing of the neurons, and encodes, stores, and transmits information through the unidirectional or bidirectional excitatory/inhibitory connections between the neurons.

An image or a video stream is input, and a plurality of pixel values of a plurality of pixels of each frame of the image are respectively multiplied by weights and input to a plurality of the primary feature encoding neurons, so as to activate a plurality of the primary feature encoding neurons.

For a plurality of the neurons, membrane potential is calculated to determine whether to fire, if the neurons are activated, each downstream neuron will accumulate the membrane potential, and then determine whether to fire, so that the firing will propagate in the brain-like visual neural network, weights of connections between upstream neurons and the downstream neurons are constant or dynamically adjusted through synaptic plasticity.

Working process of the brain-like visual neural network comprises: forward memorization process, memory triggering process, information aggregation process, directional information aggregation process, information transcription process, memory forgetting process, memory self-consolidation process, information component adjustment process, reinforcement learning process, novelty signal modulation process and supervised learning process.

Synaptic plasticity process comprises: unipolar upstream firing dependent synaptic plasticity process, unipolar downstream firing dependent synaptic plasticity process, unipolar upstream and downstream firing dependent synaptic plasticity process, unipolar upstream spiking dependent synaptic plasticity process, unipolar downstream spiking dependent synaptic plasticity process, unipolar spiking time dependent synaptic plasticity process, asymmetric bipolar spiking time dependent synaptic plasticity process, symmetric bipolar spiking time dependent synaptic plasticity process.

A plurality of the neurons are mapped to corresponding labels as output.

In one embodiment, a plurality of the neurons adopt spiking neurons or non-spiking neurons.

Compared with the prior art, this application embodiment includes the following advantages:

This application provides a brain-like visual neural network with forward-learning and meta-learning functions comprising the primary feature encoding module, the composite feature encoding module, comprising the active attention mechanism and automatic attention mechanism, having neural circuits that explicitly encode the location information of visual features, having forward neural pathways and reverse neural pathways, supporting top-down and bottom-up bi-directional information processing, adopting a variety of plasticity processes with biological rationality, with the ability to conduct forward-learning to rapidly encode the visual representation of the input image or video information to memorize information, and to conduct information abstraction process and information component adjustment process to obtain the common feature information and different feature information between objects, forming information channels with multiple information dimensions and information abstraction degrees, improving generalization ability while retaining detailed information. The brain-like visual neural network also supports reinforcement learning, supervised learning, and novelty signal modulation processes and does not rely on the end-to-end training paradigm of error back-propagation and gradient descent, which breaks through the bottleneck of the existing deep learning theory and provides a foundation for the design and application of neuromorphic chips.

### DESCRIPTION OF THE DRAWINGS

In order to explain the embodiments of the present invention or the technical solutions in the prior art more clearly, the following will briefly introduce the drawings that need to be used in the description of the embodiments or the prior art. Obviously, the drawings in the following description are only embodiments of the present invention. For those ordinary technicians in the art, other drawings can be obtained based on the provided drawings without creative work.

FIG. 1 is an overall block diagram of a brain-like visual neural network with forward-learning and meta-learning functions provided by the present invention;

FIG. 2 is a schematic diagram of an input-side attention control unit and an output-side attention control unit in a composite feature encoding module of a brain-like visual neural network with forward-learning and meta-learning functions in an embodiment of the present invention;

FIG. 3 is a schematic diagram of a position encoding unit in a composite feature encoding module of a brain-like visual neural network with forward-learning and meta-learning functions in an embodiment of the present invention;

FIG. 4 is a topological schematic diagram of the input-side attention control unit, the concrete feature encoding unit, and the abstract feature encoding unit of a brain-like visual neural network with forward-learning and meta-learning functions in an embodiment of the present invention;

FIG. 5 is a schematic diagram of the input side attention control unit and the concrete feature encoding unit, the abstract feature encoding unit and the output side attention control unit of a brain-like visual neural network with forward-learning and meta-learning functions in an embodiment of the present invention;

FIG. 6 is a schematic diagram of the position encoding neuron topology of the corresponding subspace of a brain-like visual neural network with forward-learning and meta-learning functions in an embodiment of the present invention;

FIG. 7 is a schematic diagram of the position-encoding neuron topology of a corresponding region of a brain-like visual neural network with forward-learning and meta-learning functions in an embodiment of the present invention;

FIG. 8 is a schematic diagram of the projection relationship of receptive fields of a brain-like visual neural network with forward-learning and meta-learning functions in an embodiment of the present invention;

FIG. 9 is a schematic diagram of the forward neural pathway and the reverse neural pathway of a brain-like visual neural network with forward-learning and meta-learning functions in an embodiment of the present invention; and

FIG. 10 is a schematic diagram of the centre-periphery topology structure of a brain-like visual neural network with forward-learning and meta-learning functions in an embodiment of the present invention.

### DETAILED DESCRIPTION

The technical solutions in the embodiments of the present invention will be clearly and completely explained below in conjunction with the accompanying drawings in the embodiments of the present invention. Obviously, the embodiments are only a part of the embodiments of the present invention, rather than all the embodiments. Based on the embodiments of the present invention, all other embodiments obtained by those of ordinary skill in the art without creative work shall fall within the protection scope of the present invention.

In order to explain the technical scheme of this application, the following details are given in combination with the specific drawings and embodiments.

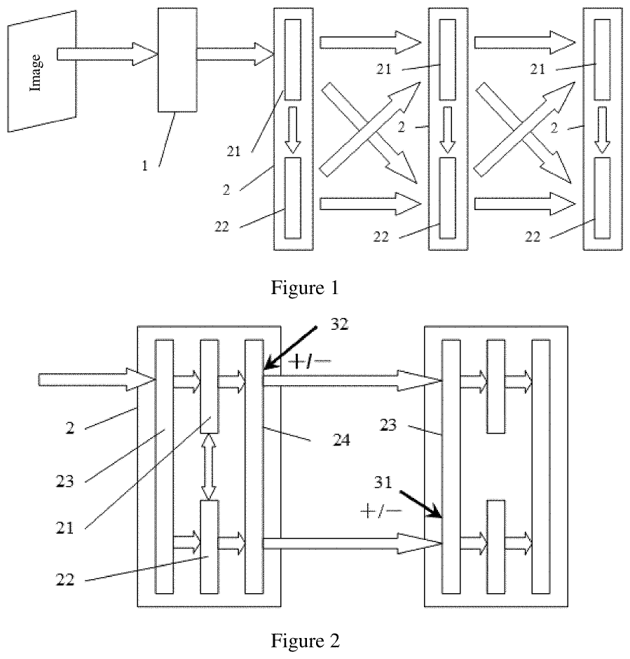

As shown in FIG. 1, the present application provides a brain-like visual neural network with forward-learning and meta-learning functions, comprising a plurality (such as 1 or 2) of primary feature encoding modules 1 and a plurality (such as 3 to 3,000) of composite feature encoding modules 2.

The primary feature encoding modules and the composite feature encoding modules each comprises a plurality of neurons.

The plurality of the neurons comprises a primary feature encoding neuron 10, a concrete feature encoding neuron 210, and an abstract feature encoding neuron 220.

Each primary feature encoding module 1 comprises a plurality (such as 2 millions) of the primary feature encoding neurons 10 for encoding primary visual feature information.

Each composite feature encoding module 2 comprises a concrete feature encoding unit 21 and an abstract feature encoding unit 22.

The concrete feature encoding unit 21 comprises a plurality (such as 100,000) of the concrete feature encoding neurons 210 for encoding concrete visual feature information.

The abstract feature encoding unit 22 comprises a plurality (such as 100,000) of the abstract feature encoding neurons 220 for encoding abstract visual feature information.

In the expression, if unidirectional connections are formed between neuron A and neuron B, it means unidirectional connections of A->B, if bidirectional connections are formed between neuron A and neuron B, it means A<->B (or A->B and A<-B) bidirectional connections.

If there is an A->B unidirectional connection between neuron A and neuron B, then neuron A is called the direct upstream neuron of neuron B, and neuron B is called the direct downstream neuron of neuron A, if a bidirectional connection of A<->B between neuron A and neuron B, then neuron A and neuron B are direct upstream neurons and direct downstream neurons.

If there is no connection between neuron A and neuron B, but they are connected by one or more other neurons, such as A->C-> . . . ->D->B, then neuron A is called the indirect upstream neuron of neuron B, neuron B is called the indirect downstream neuron of neuron A, and neuron D is called the direct upstream neuron of neuron B.

The excitatory connection is: when the upstream neurons of the excitatory connection activate, non-negative input is provided to the downstream neurons through the excitatory connection.

The inhibitory connection is: when the upstream neurons of the inhibitory connection activate, non-positive input is provided to the downstream neurons through the inhibitory connection.

A plurality (such as 10,000) of the primary feature encoding neurons 10 respectively form unidirectional or bidirectional excitatory/inhibitory connections with a plurality (such as 1 to 20) of other said primary feature encoding neurons 10.

A plurality (such as 500,000 to 1 million) of the primary feature encoding neurons 10 and a plurality (such as 10 to 1,000) of the concrete feature encoding neurons 210 or a plurality (e.g., 10 to 1,000) of the abstract feature encoding neurons 220 located in at least one (such as 2) of the composite feature encoding modules 2 respectively form the unidirectional or bidirectional excitatory/inhibitory connections.

A plurality (such as 50,000) of the concrete feature encoding neurons 210 located in a same composite feature encoding module 2 and a plurality (such as 5,000) of the abstract feature encoding neurons 220 located in the same composite feature encoding module 2 respectively form the unidirectional or bidirectional excitatory/inhibitory connections.

A plurality (such as 50,000) of the concrete feature encoding neurons 210 and the abstract feature encoding neurons 220 in a plurality (such as 3 to 3,000) of the composite feature encoding modules 2 respectively form the unidirectional or bidirectional excitatory/inhibitory connections with a plurality (such as 2,000) of the concrete feature encoding neurons 210 and the abstract feature encoding neurons 220 of a plurality (such as 1 to 300) of other composite feature encoding modules 2.

The brain-like visual neural network buffers and encodes information through firing of the neurons, and encodes, stores, and transmits information through the unidirectional or bidirectional excitatory/inhibitory connections between the neurons.

An image or a video stream is input, and a plurality of pixel values R, G, B of a plurality of pixels of each frame of the image are respectively multiplied by weights and input to a plurality (such as 2 to 30) of the primary feature encoding neurons 10, so as to activate a plurality of the primary feature encoding neurons 10.

For a plurality of the neurons, membrane potential is calculated to determine whether to fire, if the neurons are activated, each downstream neuron will accumulate the membrane potential, and then determine whether to fire, so that the firing will propagate in the brain-like visual neural network, weights of connections between upstream neurons and the downstream neurons are constant or dynamically adjusted through synaptic plasticity.

The working process of the brain-like visual neural network comprises: forward memorization process, memory triggering process, information aggregation process, directional information aggregation process, information transcription process, memory forgetting process, memory self-consolidation process, information component adjustment process, reinforcement learning process, novelty signal modulation process and supervised learning process.

The synaptic plasticity process comprises: unipolar upstream firing dependent synaptic plasticity process, unipolar downstream firing dependent synaptic plasticity process, unipolar upstream and downstream firing dependent synaptic plasticity process, unipolar upstream spiking dependent synaptic plasticity process, unipolar downstream spiking dependent synaptic plasticity process, unipolar spiking time dependent synaptic plasticity process, asymmetric bipolar spiking time dependent synaptic plasticity process, symmetric bipolar spiking time dependent synaptic plasticity process.

A plurality of the neurons are mapped to corresponding labels as output. For example, the 10,0000 abstract feature encoding neurons 220 of the advanced information channel are mapped to the corresponding label as the output.

In the present embodiment, a plurality of the neurons adopt spiking neurons or non-spiking neurons.

In this embodiment, all of the primary feature encoding neurons 10, the concrete feature encoding neurons 210, the abstract feature encoding neurons 220, and the interneurons use spiking neurons.

For example, a spiking neuron is realized by using a spiking neuronleaky integrate and fire neuron (LIF neuron model), and a non-spiking neuron is realized by an artificial neuron of a deep neural network (for example by adopting a ReLU activation function).

In this embodiment, a plurality of neurons of the brain-like visual neural network are spontaneous firing neurons, and the spontaneous firing neurons comprise conditionally spontaneous firing neurons and unconditionally spontaneous firing neurons.

If the conditionally spontaneous firing neurons are not fired by external input in first pre-set time interval, the conditionally spontaneous firing neurons will auto fire according to probability P.

Membrane potential of the unconditionally spontaneous firing neurons accumulates automatically and gradually without the external input, when the membrane potential reaches a threshold, the unconditionally spontaneous firing neurons fire, and the membrane potential is restored to resting potential to restart accumulation process.

In this embodiment, an unconditionally spontaneous firing neuron is implemented in the following way:
step m1: letting membrane potential to be Vm=Vm+Vc,
step m2: summing all inputs weighted and superimposed to Vm,
step m3: if Vm>=threshold, then letting the unconditionally spontaneous firing neuron activates and letting Vm=Vrest, and
repeating steps m1 to m3,

where Vm is the membrane potential, Vc is the cumulative constant, Vrest is the resting potential, and threshold is the threshold.

In this embodiment, the conditionally spontaneous firing neurons will auto fire according to probability P if it is not activated by an external input in the first pre-set time interval (for example, configured as 10 minutes).

The conditionally spontaneous firing neurons record one or more of:
1) time interval since last activation,
2) most recent average firing rate,
3) duration of most recent activation,
4) total activation times,
5) total number of executions of the synaptic plasticity processes in each input connections recently,
6) total number of executions of the synaptic plasticity processes in each output connections recently,
7) total change in weights of each input connections recently, and
8) total change in weights of each output connections recently.

In the present embodiment, calculation rules for the probability P comprises one or more of:
1) P is positively correlated with the time interval since the last activation,
2) P is positively correlated with the most recent average firing rate,
3) P is positively correlated with the duration of the most recent activation,
4) P is positively correlated with the total activation times,
5) P is positively correlated with the total number of executions of the synaptic plasticity processes in each input connections recently,
6) P is positively correlated with the total number of executions of the synaptic plasticity processes in each output connections recently,
7) P is positively correlated with the total change in weights of each input connections recently,
8) P is positively correlated with the total change in weights of each output connections recently,
9) P is positively correlated with average weights of all input connections,
10) P is positively correlated with total modulus of the weights of all input connections,
11) P is positively correlated with total number of all input connections, and
12) P is positively correlated with the total number of all output connections.

In the present embodiment, let P=min (1, a*Tinterval\hat{ }2+b*Fr+c*Nin_plasticity+Bias), where a, b, and c are coefficients, and Tinterval is the time interval from the last activation, Fr is the recent average exciting rate, Nin_plasticity is the total number of executions of the synaptic plasticity process of each input connection recently, and Bias is the bias, which can be set to 0.01, which is regarded as the basic spontaneous firing probability.

In the present embodiment, calculation rules for activation intensity or firing rate Fs of the conditionally spontaneous firing neurons during spontaneous firing comprise one or more of:
1) Fs=Fsd, Fsd is default activation frequency,
2) Fs is negatively correlated with the time interval since the last activation,
3) Fs is positively correlated with the most recent average firing rate,
4) Fs is positively correlated with the duration of the most recent activation,
5) Fs is positively correlated with the total number of activations,
6) Fs is positively correlated with the total number of executions of the synaptic plasticity processes of each input connections recently,
7) Fs is positively correlated with the total number of executions of the synaptic plasticity processes of each output connections recently,
8) Fs is positively correlated with the total weights change of each input connections recently,
9) Fs is positively correlated with the total weights change of each output connections recently,
10) Fs is positively correlated with the average weights of all input connections,
11) Fs is positively correlated with the total modulus of the weights of all input connections,
12) Fs is positively correlated with the total number of all input connections, and
13) Fs is positively correlated with the total number of all output connections,

If the conditionally spontaneous firing neuron is a spiking neuron, P is the probability of a series of spiking currently being excited, if the conditionally spontaneous firing neuron is excited, the firing rate is Fs, and if the conditionally spontaneous firing neuron is not activated, the firing rate is 0.

In this embodiment, 500,000 to 1 million of the primary feature encoding neurons 10, 10 million of the concrete feature encoding neurons 210, and 10 million of the abstract feature encoding neurons 220, 1 million of the input-side attention control neurons 230 adopt the conditional spontaneous firing neuron, and 500,000 to 1 million primary feature encoding neurons 10 adopt the unconditional spontaneous firing neurons.

If the conditionally spontaneous firing neuron is a non-spiking neuron, P is the probability of current activation, if the conditionally spontaneous firing neuron is activated, the activation intensity is Fs, and if the conditionally spontaneous firing neuron is not activated, the activation intensity is 0.

In this embodiment, each neuron and each connection (including neuron-neuron connection and synapse-synapse connection) can be represented by vector or matrix. The operation of the brain-like neural network is represented by vector or matrix operation. For example, if the parameters of the same kind in each neuron and each connection (such as the firing rate of the neuron and the weight of the connection) are tiled into a vector or matrix, the signal propagation of the brain-like neural network can be expressed as the dot multiplication operation of the firing rate vector of the neuron and the weight vector of the connection (that is, the weighted sum of the input).

In another embodiment, each neuron and each connection (including neuron-neuron connection and synapse-synapse connection) can also be implemented by objectification. For example, if they are respectively implemented as an object (object in object-oriented programming), the operation of the brain-like neural network is represented as the invocation of objects and the transfer of information between objects.

In another embodiment, the brain-like neural network can also be implemented in the form of firmware (e.g., FPGA) or ASIC (e.g., neuromorphic chip).

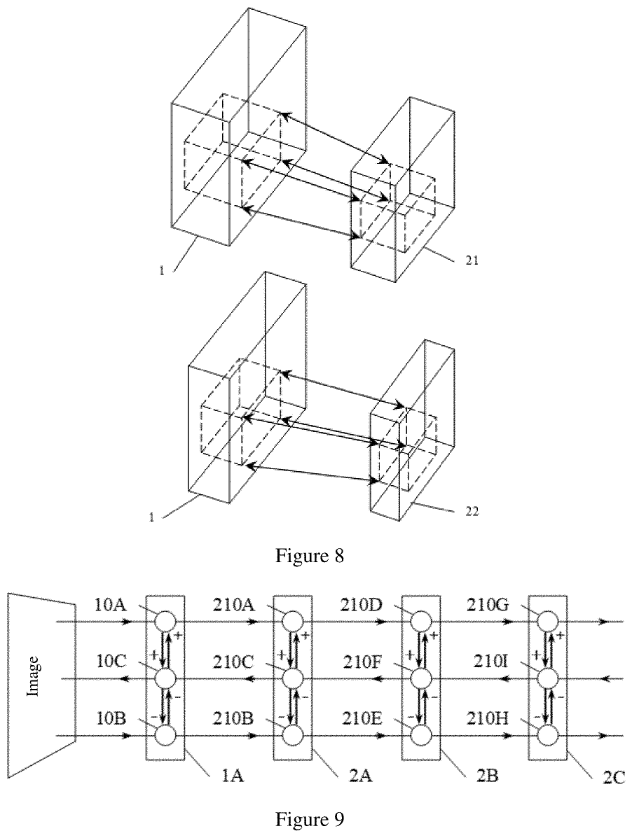

In another embodiment, a plurality of the connections of the brain-like visual neural network can be replaced by convolution operations. For example, all connections between each primary feature encoding neuron 10 and each concrete feature encoding neuron 210 can use a convolution operation, and can also generate signal projection relationships with one or more receptive fields. FIG. 8 shows the projection relationship of the receptive fields.

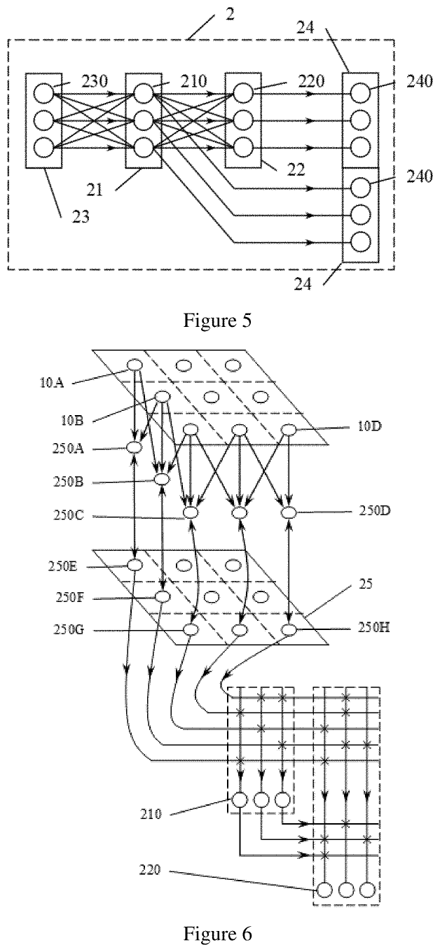

As shown in FIGS. 2, 3, 4 and 5, in a further improved embodiment, the composite feature encoding module 2 further comprises an input-side attention control unit and an output-side attention control unit.

The neurons further comprise an input-side attention control neuron 230 and an output-side attention control neuron 240.

The input-side attention control unit comprises a plurality (such as 100,000) of the input-side attention control neurons 230.

The output-side attention control unit comprises a plurality (such as 100,000) of the output-side attention control neurons 240.

A plurality (such as 50,000) of the input attention control neurons 230 can receive the unidirectional or bidirectional excitatory/inhibitory connections of a plurality (e.g., 100,000 to 10,000) of the primary feature encoding neurons 10 respectively.

Each of the input-side attention control neurons forms unidirectional or bidirectional excitatory connections with a plurality (e.g., 1 to 1,000) of the concrete feature encoding neurons 210 or the abstract feature encoding neurons 220 of the composite feature encoding module 2.

Each of the input-side attention control neurons 230 forms the unidirectional or bidirectional excitatory connections with a plurality (such as 100,000 to 10,000) of the concrete feature encoding neurons 210 or the abstract feature encoding neurons 220 or the output-side attention control neurons 240 from said other composite feature encoding modules 2.

Each input-side attention control neuron 230 can also form the unidirectional or bidirectional excitatory connections with a plurality (e.g., 1,000) of other input-side attention control neurons 230, respectively.

Each of the output-side attention control neurons 240 forms unidirectional or bidirectional excitatory connections with a plurality (e.g., 1,000 to 10,000) of the concrete feature encoding neurons 210 or the abstract feature encoding neurons 220 or the input-side attention control neurons 230 located in said other composite feature encoding modules 2.

Each of the output-side attention control neurons 240 receives the unidirectional or bidirectional excitatory connections from a plurality (e.g., 1 to 1,000) of the concrete feature encoding neurons 210 or the abstract feature encoding neurons 220 from the composite feature encoding module 2 where said each of the output-side attention control neurons 240 is located.

Each of the output-side attention control neurons 240 can also form the unidirectional or bidirectional excitatory connections with a plurality (e.g., 1,000) of other output-side attention control neurons 240.

Each of the input-side attention control neurons 230 can have an input-side attention control end 31. Each of the output-side attention control neurons 240 can have an output-side attention control end 32.

The working process of the brain-like visual neural network further comprises active attention process and automatic attention process.

The active attention process comprises: adjusting activation intensity or firing rate or spiking firing phase of each input-side attention control neuron 230 through adjusting strength (the amplitude can be positive, negative, or 0) of attention control signal applied at the input-side attention control end 31, thereby controlling the information entering corresponding concrete feature encoding units 21 and corresponding abstract feature encoding units 22, and adjusting size and proportion of each information component, or adjusting the activation intensity or the firing rate or the spiking firing phase of each output-side attention control neuron 240 by adjusting the strength (the amplitude can be positive, negative, or 0) of the attention control signal applied at the output side attention control end, thereby controlling information output from the corresponding concrete feature encoding units 21 and the corresponding abstract feature encoding units 22, and adjusting the size and proportion of each information component.

The automatic attention process comprises: when a plurality of the neurons connected to the input-side attention control neurons 230 are activated, making the input-side attention control neurons 230 more easily activated, so that relevant information components are more easily input to the corresponding concrete feature encoding units 21 and the corresponding abstract feature encoding unit 22, or, when a plurality of the neurons connected to the output-side attention control neurons 240 are activated, making the output-side attention control neurons 240 more easily activated, so that the relevant information components are more easily output from the corresponding concrete feature encoding units 21 and the corresponding abstract feature encoding units 22.

In a further improved embodiment, the brain-like visual neural network comprises one or more information channels.

The working process of the brain-like visual neural network further comprises information channel automatic formation process.

The information channel automatic formation process comprises: adjusting connection relationship and weights between the neurons by performing one or more of the forward memorization process, the memory triggering process, the information aggregation process, the directional information aggregation process, the information transcription process, the memory forgetting process, the memory self-consolidation process and the information component adjustment process, so that the brain-like visual neural network forms said one or more information channels, and each information channel encodes one or more information components, there can be crossover between the information channel.

The neural network can also form said one or more information channels by pre-setting initial connection relationship and initial parameters (such as connection weights, threshold of the neurons, initial membrane potential of the neurons and initial time constant of the neurons), and each information channel encodes one or more pre-set information components.

In this embodiment, the information channels comprise primary information channels.

The primary information channel is: all the primary feature encoding neurons' connections constitute the primary information channels.

The primary information channels comprise primary contrast information channels, primary orientation information channels, primary edge information channels, and primary colour block information channels.

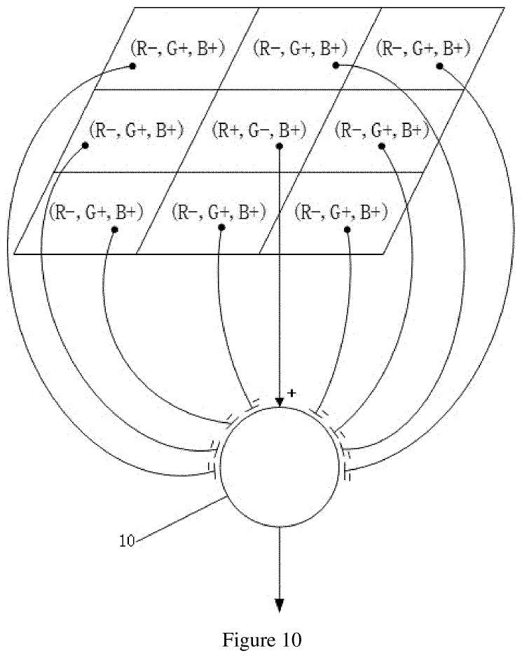

As shown in FIG. 10, the primary contrast information channels are formed by: selecting a plurality of adjacent pixels in input image as central area pixels, selecting a plurality of the pixels around the central area pixels as surrounding area pixels, and multiplexing a plurality of pixel values of the central region pixels and the surrounding region pixels by the weights and input to a plurality of the primary feature encoding neurons 10, i.e., forming a central-surrounding topology structure, the feature encoding neurons 10 and the feature encoding neurons' connections form one or more said primary contrast information channels.

In the primary information channels, one or more similar pixels with similar numbers, locations of image space covered by similar pixels and areas of the image space covered by the similar pixels are selected, one or more of the pixel values of said similar pixels are respectively multiplied by one or more of the weights, one or more of the primary orientation information channels, the primary edge information channels, the primary colour block information channels or synthesis thereof that are with one or more receptive fields can be formed.

For example, the R, G, B pixel values of one said central region pixel are respectively multiplied by negative weight (e.g., −2), negative weight (e.g., −2), and positive weight (e.g., +4) into several (e.g., 1 to 2) said primary feature encoding neurons 10. The R, G and B pixel values of the surrounding area pixels in the top left (e.g., 1) and bottom right (e.g., 1) are multiplied by a negative weight (e.g., −2), a negative weight (e.g., −2), and a positive weight (e.g., +4), respectively. The above (such as 1), below (such as 1), left (such as 1), right (e.g., 1), upper right (such as 1), bottom left (e.g., 1) the in the surrounding area of the pixels of R, G, B pixel values are multiplied by positive weights (+2), negative weight (−4) and input to the primary feature encoding neurons 10. These primary features encoding neurons 10 and their connections constitute information channels with a 3×3 receptive field with blue-yellow contrast and a 45° orientation sensitivity from top left to bottom right.

For example, in a 15×15 pixel area, the R, G, and B values of each pixel are multiplied by negative weight, negative weight, and positive weight, respectively, and input to several (such as 1 to 2) of the primary feature encoding neurons 10. These primary feature encoding neurons 10 and their connections constitute a blue-sensitive colour patch information channel.

The primary contrast information channels comprise light-dark contrast information channels, dark-light contrast information channels, red-green contrast information channels, green-red contrast information channels, yellow-blue contrast information channels, and blue-yellow contrast information channels.

The light-dark contrast information channels are formed by: respectively multiplying R, G, and B pixel values of each central area pixel (such as 9 in total) by positive weights (such as +1) and inputting to a plurality (such as 1 to 10) of the primary feature encoding neurons 10, and respectively multiplying the R, G, and B pixel values of each surrounding area pixel (such as 72 in total) by negative weights (such as −1) and inputting to a plurality of the primary feature encoding neurons 10, the primary feature encoding neurons 10 and the primary feature encoding neurons' connections form the light-dark contrast information channels.

The dark-light contrast information channels are formed by: respectively multiplying the R, G, and B pixel values of each central area pixel (such as 9 in total) by the negative weights (such as −1) and inputting to a plurality (such as 1 to 10) of the primary feature encoding neurons 10, and respectively multiplying the R, G, and B pixel values of each surrounding area pixel (such as 72 in total) by the positive weights (such as +1) and inputting to a plurality of the primary feature encoding neurons 10, the primary feature encoding neurons 10 and the primary feature encoding neurons' connections form the dark-light contrast information channels.

As shown in FIG. 10, the red-green contrast information channels are formed by: respectively multiplying the R, G, and B pixel values of each central area pixel (such as 4 in total) by the positive weights (such as +2), the negative weights (such as −2) and the positive weights (such as +1) and inputting to a plurality (such as 1 to 10) of the primary feature encoding neurons 10, and respectively multiplying the R, G, and B pixel values of each surrounding area pixel (such as 32 in total) by the negative weights (−2), the positive weights (such as +2) and the negative weights (such as +1) and inputting to a plurality of the primary feature encoding neurons 10, the primary feature encoding neurons 10 and the primary feature encoding neurons' connections form the red-green contrast information channels.

The green-red contrast information channels are formed by: respectively multiplying the R, G, and B pixel values of each central area pixel (such as 4 in total) by the negative weights (such as −2), the positive weights (such as +2) and the positive weights and inputting to a plurality (such as 1 to 10) of the primary feature encoding neurons 10, and respectively multiplying the R, G, and B pixel values of each surrounding area pixel (such as 32 in total) by the positive weights (such as +2), the negative weights (such as −2) and the positive weights (such as +1) and inputting to a plurality of the primary feature encoding neurons 10, the primary feature encoding neurons 10 and the primary feature encoding neurons' connections form the red-green contrast information channels.

The yellow-blue contrast information channels are formed by: respectively multiplying the R, G, and B pixel values of each central area pixel (such as 4 in total) by the positive weights (such as +2), the positive weights (such as +2) and the negative weights (such as −4) and inputting to a plurality (such as 1 to 10) of the primary feature encoding neurons 10, and respectively multiplying the R, G, and B pixel values of each surrounding area pixel (such as 32 in total) by the negative weights (such as −2), the negative weights (such as −2) and the positive weights (such as +4) and inputting to a plurality of the primary feature encoding neurons 10, the primary feature encoding neurons 10 and the primary feature encoding neurons' connections form the yellow-blue contrast information channels.

The blue-yellow contrast information channels are formed by: respectively multiplying the R, G, and B pixel values of each central area pixel (such as 4 in total) by the negative weights (such as −2), the negative weights (such as −2) and the positive weights (such as +4) and inputting to a plurality of the primary feature encoding neurons (such as 1 to 10), and respectively multiplying the R, G, and B pixel values of each surrounding area pixel (such as 32 in total) by the positive weights (such as +2), the positive weights (such as +2) and the negative weights (such as −4) and inputting to a plurality of the primary feature encoding neurons 10, the primary feature encoding neurons 10 and the primary feature encoding neurons' connections form the blue-yellow contrast information channels.

Specifically, the primary visual feature information comprises light-dark contrast information, dark-light contrast information, red-green contrast information, green-red contrast information, yellow-blue contrast information, blue-yellow contrast information, primary edge information, primary orientation information, receptive fields information, and colour block information.

In a further improved embodiment, the primary information channels comprise primary optical flow information channels.

The primary optical flow information channels are formed by: calculating optical flow of a plurality of the pixels in the input image respectively to obtain direction value and speed value of movement of the optical flow, combining different direction values and speed values, and respectively multiplying the weights and inputting to a plurality (such as 1 to 10) of said primary feature encoding neurons 10, the primary feature encoding neurons 10 and the primary feature encoding neurons' connections form the primary optical flow information channels.

The primary visual feature information also comprises optical flow information.

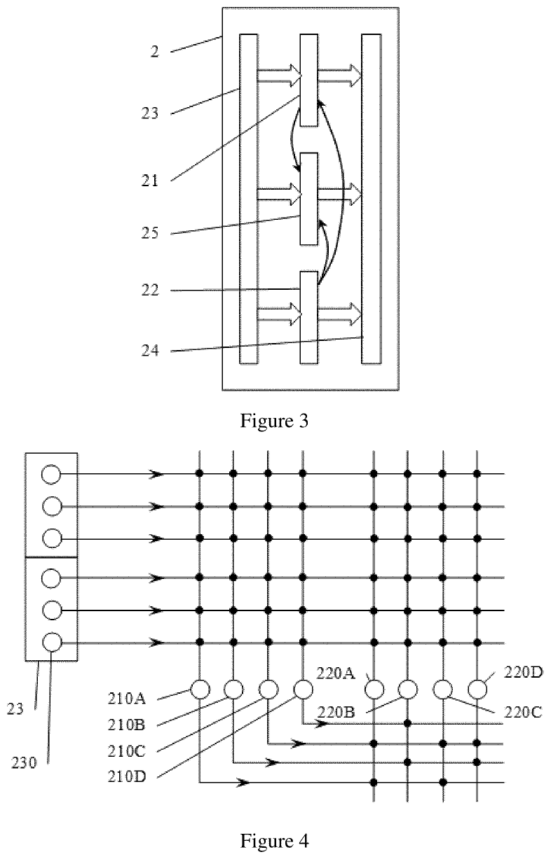

As shown in FIGS. 3, 6 and 7, the composite feature encoding module 2 further comprises a plurality (such as 1 to 10) of position encoding units 25.

The neurons comprise position encoding neurons 250.

The position encoding units 25 comprise a plurality (such as 1,000 to 10,000) of the position encoding neurons 250 for encoding position information (visual features relative to the image space or relative to other visual features).

Each of the position encoding units 25 respectively corresponds to a plurality of subspaces in the image space, and each subspace can have an intersection.

Each position encoding neuron 250 respectively corresponds to each region corresponding to said each position encoding neuron 25's position in each subspace corresponding to the position encoding unit, and accepts the unidirectional or bidirectional excitatory connections of a plurality (such as 1,000 to 10,000) of the neurons (such as the primary feature encoding neurons 10) whose receptive fields are said regions. The projection relationship of the receptive fields can be seen in FIG. 8.

A plurality of (such as all of) the position encoding neurons 250 respectively form the unidirectional or bidirectional excitatory connections with a plurality of other position encoding neurons 250 corresponding to same region where the position encoding neurons are located.

A plurality (such as 1,000 to 50,000) of said position encoding neurons 250 can also form the unidirectional or bidirectional excitatory connections with a plurality (such as 1 to 1,000) of the input-side attention control neurons 230/the output-side attention control neurons 240/the concrete feature encoding neurons 210/the abstract feature encoding neurons 220 located in the composite feature encoding module where said position encoding neurons are located.

A plurality (such as 1,000 to 50,000) of the position encoding neurons 250 can also respectively form the unidirectional or bidirectional excitatory connections with a plurality (such as 1 to 1,000) of the input-side attention control neurons 230/the concrete feature encoding neurons 210/the abstract feature encoding neurons 220 located in said other composite feature encoding modules 2.

For example, in FIG. 6, the position encoding neurons 250A, 250B, 250C, and 250D respectively correspond to some subspaces/regions in the video space, and their corresponding subspaces/regions have an intersection with each other. The positions encoding neurons 250A, to 250B, 250C, and 250D respectively correspond to the same regions as the position encoding neurons 250E, 250F, 250G, and 250H, and they respectively form a bidirectional excitatory connection.

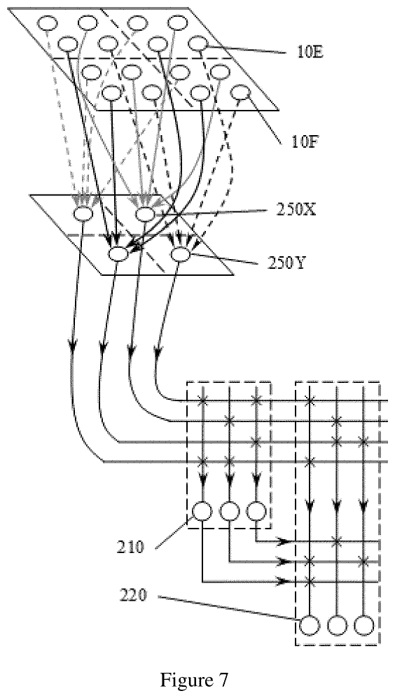

In another example, in FIG. 7, the position encoding neuron 250Y accepts the excitatory connection of the primary feature encoding neurons 10E, 10F, etc., in each region corresponding to the position in the four subspaces.

The information channels further comprise intermediate information channels.

The intermediate information channels comprise intermediate position information channels.

The intermediate position information channels are formed by: through the automatic formation process of the information channel, or through pre-setting the initial connection relationship and the initial parameters, the proportion of total weights of the connections of the position encoding neurons 250 and neurons that encode the position information in the total weights of part or all of the connections of the input-side attention control neurons 230/the output-side attention control neurons 240/the concrete feature encoding neurons 210/the abstract feature encoding neurons 220 of a plurality (such as 1 to 10) of the composite feature encoding modules is made to reach or exceed a first pre-set ratio (such as 30%), and connection weights from the position encoding neurons 250 and the neurons that encode the position information are made to be combined in variety of proportions, so that the input-side attention control neurons 230/the output-side attention control neurons 240/the concrete feature encoding neurons 210/the abstract feature encoding neurons 220 respectively have one or more of the receptive fields, respectively encode one or more of the position information, and together with the position encoding neurons 250 form the intermediate position information channels.

Since the intermediate position information channel includes neurons encoding the position information of the visual features, an explicit position encoding method is adopted.

In this embodiment, the intermediate information channels comprise intermediate visual feature information channels.

The intermediate position information channels are formed by: through the information channel automatic formation process, or through pre-setting the initial connection relationship and the initial parameters, the proportion of total weights of the connections of the neurons that are from the primary information channels in the total weights of part or all of the connections of the input-side attention control neurons 230/the output-side attention control neurons 240/the concrete feature encoding neurons 210/the abstract feature encoding neurons 220 of a plurality of the composite feature encoding modules 2 is made to reach or exceed a second pre-set ratio (such as 60%), and connection weights of each neuron in each region and each position in corresponding image space from the primary information channels and the intermediate information channels are combined in a variety of proportions, so that the input-side attention control neurons 230/the output-side attention control neurons 240/the concrete feature encoding neurons 210/the abstract feature encoding neurons 220 respectively have one or more of the receptive fields, respectively encode one or more kinds of intermediate visual feature information, and together form the intermediate visual feature information channels.

Specifically, the intermediate visual feature information includes composite colour contrast information, composite light-dark contrast information, composite orientation information, composite edge information, area information, and motion information.

For example, select 1 to 10 of the composite feature encoding modules 2 to make 80% of the input-side attention control neurons 230/output-side attention control neurons 240/concrete feature encoding neurons 210/abstract feature encoding neurons 220 receive the unidirectional excitatory connections from each neuron of the two primary orientation information channels, such that the neurons of the composite feature encoding module 2 encode the primary orientation information encoded by the two primary orientation information channels (one is horizontal to the right direction, and the other one is the 10° direction from upper left to bottom right, and the receptive field is 9×9), that is, the comprehensive orientation information (from the horizontal to the right to the top left to the bottom right 10° direction interval, the receptive field is 9×9).

Since the neurons of the intermediate visual feature information channel directly accept the connections from the neurons of the primary information channel, the receptive field is formed by corresponding regions and locations in the image space through these connections, that is, the implicit position encoding method is adopted.

In a further improved embodiment, the information channels comprise advanced visual information channels.

The intermediate information channel comprises an intermediate position information channel.

The intermediate position information channels are formed by: through the information channel automatic formation process, or through pre-setting the initial connection relationship and the initial parameters, the proportion of total weights of the connections of the neurons that are from said intermediate information channels in the total weights of part or all (such as 80% of the total) of the connections of the input-side attention control neurons 230/the output-side attention control neurons 240/the concrete feature encoding neurons 210/the abstract feature encoding neurons 220 of a plurality (such as 10 to 2,000) of the composite feature encoding modules 2 is made to reach or exceed a third pre-set ratio (for example 40%), and connection weights of each neuron in each region and each position in corresponding image space from the primary information channels, the intermediate information channels and the advanced information channels are combined in a variety of proportions, so that the input-side attention control neurons 230/the output-side attention control neurons 240/the concrete feature encoding neurons 210/the abstract feature encoding neurons 220 respectively have one or more of the receptive fields, respectively encode one or more kinds of advanced visual feature information, and together form the advanced information channels.

Specifically, the advanced visual feature information comprises contour information, texture information, brightness information, transparency information, shape and position information, composite motion information, and object information.

The object information is the identified object (it can be an instance or a category), and each object can have a name, such as “apple”, “banana”, and “car”.

For example, select 1 to 10 of the composite feature encoding modules 2 to make 80% of the input-side attention control neurons 230/output-side attention control neurons 240/concrete feature encoding neurons 210/abstract feature encoding neurons 220 respectively accept unidirectional excitatory connections of neurons from multiple intermediate information channels. These intermediate information channels encode composite edge information and position information, and the neurons of the composite feature encoding module 2 encode shape and position information.

In this embodiment, a basic working process of the brain-like neural network, its modules or units is: respectively selecting a number of, in several candidate neurons (in a certain module or sub-module), vibrating neurons, source neurons, target neurons, and making a certain number of the vibrating neurons generate a certain activation distribution and maintain activation for a certain period of time or operation cycle, so as to adjust the weights of the connections between the neurons participating in said work process through the synaptic plasticity process.

The activation distribution is that a number of the neurons produce the same or different activation intensity, firing rate, and pulse phase, respectively.

For example, neurons A, B, and C produce activation intensities of amplitude 2, 5, and 9, or firing rates of 0.4 Hz, 50 Hz, and 20 Hz, or pulse phases of 100 ms, 300 ms, and 150 ms, respectively.

The process of selecting vibrating neurons, source neurons or target neurons from a plurality of candidate neurons comprises one or more of: selecting part or all of first Kf1 neurons with smallest weights total module length of the input connections, selecting part or all of first Kf2 neurons with smallest weights total module length of the output connections, selecting part or all of first Kf3 neurons with largest weights total module length of the input connections, selecting first Kf4 neurons with the largest total weights module length of the output connections, and selecting first Kf5 with largest activation intensity or activation rate or first to be excited, selecting first Kf6 neurons with smallest activation intensity or activation rate or latest to be activated (including not activated), selecting first Kf7 neurons that have been longest since last activation, selecting first Kf8 neurons that have been closest since the last activation, selecting first Kf9 neurons that have been longest since the last time when the input connections or the last output connections perform the synaptic plasticity process, and selecting first Kf10 that have been closest since the last time when the input connections or the last output connections perform the synaptic plasticity process.

In this embodiment, the method for a plurality of the neurons to generate a activation distribution and maintain a pre-set period (such as 200 ms to 2 s) of activation comprises:

inputting samples (images or video streams), directly activating one or more of the neurons in the brain-like neural network, letting one or more of the neurons in the brain-like neural network to be self-excited, and transmitting existing activation states of one or more of the neurons in the brain-like neural network, so as to activate one or more of the neurons (such as the vibrating neurons).

As shown in FIG. 9, in this embodiment, the brain-like visual neural network comprises a forward neural pathway and a reverse neural pathway.

The forward neural pathway and the reverse neural pathway are respectively: a plurality of the primary feature encoding modules 1/the composite feature encoding modules 2 are cascaded in a first pre-set order, and a first neural pathway composed of a plurality of the neurons cascaded along the first pre-set order is regarded as the forward neural pathway, and a second neural pathway composed of a plurality of the neurons cascaded against the first pre-set order is regarded as the reverse neural pathway.

Specifically, the first pre-set order is the primary information channel, the intermediate information channel, the advanced information channel. The forward neural pathway is a neural pathway in which neurons of a plurality of the primary information channels, intermediate information channels and advanced information channels cascade from bottom to top (that is, along the first pre-set order), mainly participating in the recognition of external input information (videos or video streams) and the forward-learning process. The reverse neural pathway is a neural pathway in which neurons of a plurality of the high-level information channels, intermediate information channels and primary information channels are cascaded from top to bottom (that is, against the first pre-set order), and mainly participate in the whole process of pattern completion, directional initiation, association or imagination. Specifically, the first pre-set order is the primary information channel, the intermediate information channel, the advanced information channel. The forward neural pathway is a neural pathway in which neurons of several primary information channels, intermediate information channels and advanced information channels cascade from bottom to top (that is, along the first pre-set order), mainly participating in the recognition of external input information (images or video streams) and the forward-learning process. The reverse neural pathway is a neural pathway in which neurons of a plurality of the high-level information channels, intermediate information channels and primary information channels are cascaded from top to bottom (that is, against the first pre-set order), and mainly participate in the whole process of pattern completion, directional initiation, association or imagination.

In each primary feature encoding module 1/each composite feature encoding module 2, a plurality of the neurons constituting the forward neural pathway can respectively form the unidirectional or bidirectional excitatory/inhibitory connections with a plurality of the neurons constituting the reverse neural pathway.

In this embodiment, the working process of the neural network also includes a directional start process.

Said directional start process comprises forward start process and reverse start process.

The forward start process comprises:
step o1: selecting a plurality of neurons in the forward neural pathway as the vibrating neurons,
step o2: making each of the vibrating neurons generate activation distribution and keep activating a third pre-set period Tfprime,
step o3: making a plurality of the neurons in the reverse neural pathway that receive the excitatory connections of the vibrating neurons receive non-negative input for easier activation,
step o4: making a plurality of the neurons in the reverse neural pathway that receive the inhibitory connections of the vibrating neurons receive non-positive input to reduce possibility of activation.

the reverse start process comprises:
step n1: selecting a plurality of neurons in the forward neural pathway as the vibrating neurons,
step n2: making each of the vibrating neurons generate activation distribution and keep activating a tenth pre-set period Tbprime,
step n3: making a plurality of the neurons in the forward neural pathway that receive the excitatory connections of the vibrating neurons receive non-negative input for easier activation,
step n4: making a plurality of the neurons in the forward neural pathway that receive the inhibitory connections of the vibrating neurons receive non-positive input to reduce possibility of reduce possibility of activation.

For example, Tfprime and Tbprime are configured as 5 seconds.

The directional start process can be used for visual search. During visual search, a plurality of the neurons encoding the searched information component in the reverse neural pathway are used as the vibrating neurons and generate the distribution representing the searched information component and maintain the activation of the tenth pre-set cycle Tbprime (such as configured for 5 seconds). A number of neurons in the forward neural pathway that encode the searched information component are more likely to activate, while a number of said neurons that do not encode the searched information component are inhibited. When the searched information component appears in the external input information (videos or video streams), it is easier to identify, and irrelevant information components are filtered out.

Referring to FIG. 9, for example, the neural network can be configured to comprise a primary feature encoding module 1A, a composite feature encoding module 2A, a composite feature encoding module 2B, and a composite feature encoding module 2C. These four modules respectively contain the primary feature encoding neurons 10A, 10B, and 10C, concrete features encode neurons 210A, 210B, 210C, concrete features encode neurons 210D, 210E, 210F, and concrete features encode neurons 210G, 210H, 210I.

The first pre-set order can be configured as the order of the primary feature encoding module 1A, the composite feature encoding module 2A, the composite feature encoding module 2B, and the composite feature encoding module 2C. The primary feature encoding neuron 10A, the concrete feature encoding neuron 210A, the concrete feature encoding neuron 210D and the concrete feature encoding neuron 210G are cascaded in the first pre-set order through a unidirectional excitatory connection to form a positive neural pathway A. The primary feature encoding neuron 10B, the concrete feature encoding neuron 210B, the specific feature encoding neuron 210E, and the specific feature encoding neuron 210H are cascaded through the unidirectional excitatory connection along the first pre-set order to form the forward neural pathway B. The primary feature encoding neuron 10C, the specific feature encoding neuron 210C, the specific feature encoding neuron 210F, and the specific feature encoding neuron 210I are cascaded through a unidirectional excitatory connection against the first pre-set order to form a reverse neural pathway C.

The primary feature encoding neuron 10C forms a bidirectional excitatory connection and a bidirectional inhibitory connection with the primary feature encoding neurons 10A and 10B, respectively.

The concrete feature encoding neuron 210C forms a bidirectional excitatory connection and a bidirectional inhibitory connection with the concrete feature encoding neurons 210A and 210B, respectively.

The specific feature encoding neuron 210F and the specific feature encoding neurons 210D and 210E respectively form a bidirectional excitatory connection and a bidirectional inhibitory connection.

The specific feature encoding neuron 210I and the specific feature encoding neurons 210G, 210H form a bidirectional excitatory connection and a bidirectional inhibitory connection, respectively.

Thus, the reverse neural pathway C promotes the forward neural pathway A and inhibits the forward neural pathway B.

The neurons further comprise interneurons.

The primary feature encoding module 1 and the composite feature encoding module 2 respectively comprise a plurality of the interneurons, unidirectional inhibitory connections are formed with a plurality (such as 1,000 to 10,000) of corresponding neurons in a corresponding module (such as 1 to 10,000), and a corresponding number of neurons in each module forms unidirectional excitatory connections with a plurality (for example, 1 to 10,000) of corresponding interneurons.

In this embodiment, the corresponding two or more groups of neurons in each of the modules form inter-group competition (lateral inhibition) through the interneurons. When input is applied, the competing groups of neurons produce different overall activation intensity (or firing rate) of the interneurons. The lateral inhibition of the interneurons makes the overall activation intensity (or firing rate) stronger for the strong and weaker for the weak, or makes the neurons (groups) that start firing earlier inhibit the neurons (groups) that fire later so as to form a time difference, ensuring that the information encoding of the neurons in each group is independent and decoupled from each other, and automatically grouped. Such design also allows that the input information in the process of memory triggering can trigger the memory information with the highest correlation, and the neurons participating in the directed information aggregation process can be automatically grouped into the Ga1, Ga2, Ga3, Ga4 according to the response (activation intensity or firing rate size, or release time sequence).

In the present embodiment, the neurons further comprise a differential information decoupling neuron, and the working process of the brain-like visual neural network also comprises differential information decoupling process.

The differential information decoupling process is:
selecting a plurality of input-side attention control neurons 230/the output-side attention control neurons 240/the concrete feature encoding neurons 210/the abstract feature encoding neurons 220 as target neurons,
selecting a plurality of the neurons with unidirectional/bidirectional excitatory connections with the target neurons as concrete information source neurons,
selecting a plurality of other neurons with unidirectional/bidirectional excitatory connections with the target neurons as abstract information source neurons,
each of the concrete information source neurons has a plurality of matched differential information decoupling neurons, each of the concrete information source neurons and each matched differential information decoupling neuron respectively form unidirectional excitatory connections, the information decoupling neurons respectively with input neurons form unidirectional inhibitory connections with the information source input neurons, or form unidirectional inhibitory synapse-synaptic connections with connections input from the information source neurons to the target neurons, so as to make signal input from the concrete information source neurons to the target neurons to be subject to inhibitory regulation by the matched differential information decoupling neurons, the abstract information source neurons and the differential information decoupling neurons form the unidirectional excitatory connections,
each differential information decoupling neuron can have a decoupled control signal input terminal, degree of information decoupling is adjusted by adjusting magnitude (which can be positive, negative, or 0) of the signal applied on decoupling control signal input.

The weight of the unidirectional excitatory connection between the concrete information source neuron/abstract information source neuron and the matched differential information decoupling neuron is a constant value, or is dynamically adjusted through the synaptic plasticity process.

In this embodiment, one scheme of the synapse-synaptic connection is that, the connection Sconn1 accepts the input of one or more other connections (denoted as Sconn2), and when the upstream neurons connected to Sconn1 is fired, the value passed from connection Sconn1 to downstream neurons is the weight of connection Sconn1 plus the input value of each connection Sconn2.

In this embodiment, a certain composite feature encoding module 2 is selected to perform the forward-learning process, a group of the input-side attention control neurons 230 is selected as the vibrating neuron, and a group of the concrete features encoding neurons 210 is used as a target neuron. When a novel sample (image or video stream) is input, multiple target neurons are activated and the visual feature information in the sample is encoded into concrete feature information (a type of memory information, that is, the original feature information component of each object) and stored through the forward-learning process.

Then, let the composite feature encoding module 2 perform the directional information aggregation process, select the same group of input-side attention control neurons 230 as the vibrating neurons as before, and select the same group of specific feature encoding neurons 210 as the source neurons. Select one group of the abstract feature encoding neurons 220 as the target neurons. After completing one or more of the directional information aggregation processes, the concrete feature information is aggregated into abstract feature information (a type of memory information, that is, the common feature information component between each object), which is encoded and stored by a plurality of the target neurons.

Then, let the composite feature encoding modules 2 perform the differential information decoupling process, select the same group of concrete feature encoding neurons 210 as the previous concrete information source neurons, and select the same group of abstract feature encoding neurons 220 as before is used as the abstract information source neurons, and a plurality of the output-side attention control neurons 240 of the composite feature encoding module 2 is selected as the target neuron. When the same sample was input again, multiple neurons of the concrete information source are activated to trigger the concrete feature information encoded by them, and multiple neurons of the abstract information source are also activated to trigger the abstract feature information encoded by them. These abstract information source neurons activate the differential information decoupling neurons, and then suppress the input signals from these concrete information source neurons to each target neuron, so that the abstract feature information replaces the original concrete feature information and inputs to each target neuron. In other words, the information finally output to other composite feature encoding modules through the composite feature encoding module 2 is abstract feature information.

Then, the composite feature encoding module 2 can be made to perform the information component adjustment process. Select the same group of input-side attention control neurons 230 as the vibrating neurons as before, and select the same group of specific feature encoding neurons 210 as the previous ones. For the target neuron, let the Kb1 take a smaller value (for example, 1). After completing the information component adjustment process one or more times, the feature information of each target neuron becomes differential feature information (a piece of memory information, that is, the information component that characterizes the difference between objects). At this time, the signal output from the concrete feature encoding neuron 210 to the attentional regulation neuron 240 on the output side is no longer inhibited by the differential information decoupling neuron and can be transmitted to the downstream neural network.

The whole process can be executed one or more times, so that the concrete feature information is gradually abstracted into abstract feature information, and the difference feature information is retained to form a sparser code, which saves the encoding and signal transmission bandwidth, and also makes the representation of the neural network better generalization ability (because of the formation of abstract feature information). It also allows us to form higher-level representations without losing detail (because the difference feature information is preserved).

In this embodiment, the forward-learning process comprises:
step a1: selecting a plurality of the neurons as the vibrating neurons,
step a2: selecting a plurality of the neurons as the target neurons,
step a3: adjusting the weights of the unidirectional excitatory connections between each activated vibrating neuron and each activated vibrating neuron through the synaptic plasticity process with the between one or more of the target neurons, and
step a4: allowing each activated target neuron to establish the unidirectional or bidirectional excitatory connections with one or more of the other target neurons, or establish self-circulating excitatory connections with itself, adjusting the weights of the unidirectional or bidirectional excitatory connections or the self-circulating excitatory connections through the synaptic plasticity process.

When adjusting the weights of each connection between each target neuron through the synaptic plasticity process, the weights of part or all of the input/output connections can or cannot be standardized.

In this embodiment, in the forward-learning process, 10,000 of the input-side attention control neurons 230 are selected as the vibrating neurons, and 10,000 of the concrete feature encoding neurons 210/abstract feature encoding neuron 220 can be selected to serve as a target neuron.

The forward-learning process can quickly encode the visual feature information of each object in the current input video/video stream and store it in the primary feature encoding module 1/concrete feature encoding unit 21/abstract feature encoding unit 22, which is convenient for rapid recognition when the same or similar object is seen again, provides the processing material for the information aggregation process/directional information aggregation process/information component adjustment process, finds the clustering centre of multiple similar objects (that is, the common features) and differentiated features, and is the basis of meta-learning.

In this embodiment, the memory triggering process comprises: inputting information (images or video streams) or directly activating a plurality of the neurons in the brain-like visual neural network, or allowing a plurality of the neurons in the brain-like visual neural network to be spontaneous firing, or propagating existing activation states of a plurality of the neurons in the to neural network, if a plurality of the neurons in the target area are activated in a second pre-set period (such as 1 second), representation of each neuron fired in the target area can be used together with the activation intensity of each neuron fired in the target area as the result or the firing rate of each neuron fired in the target area as a result of the memory triggering process.

The target area can be any sub-network in the neural network (for example, all abstract feature encoding neurons 220 of a certain composite feature encoding module 2).

In this embodiment, the memory-triggering process can be reflected as the recognition process of input information (image or video stream), and each issued neuron in the target area can be mapped to a number of labels through a number of readout layer neurons as the recognition results. Each neuron of the target area forms a unidirectional excitatory or inhibitory connection with a plurality of neurons of the readout layer. Each readout layer neuron corresponds to a tag. The higher its activation intensity or firing rate, or the earlier it starts issuing, the higher the correlation between the input information and its corresponding tag, and vice versa. For example, each label could be “apple,” “car,” “prairie,” and so on.

In this embodiment, the information aggregation process comprises:
step g1: selecting one or more of the neurons as the vibrating neurons,
step g2: selecting one or more of the neurons as source neurons,
step g3: selecting one or more of the neurons as the target neurons,
step g4: making each of the vibrating neurons generate activation distribution and maintain activation of eighth pre-set period Tk,
step g5: during the eighth pre-set period Tk, adjusting the weights of the unidirectional or bidirectional excitatory/inhibitory connections between each activated vibrating neuron and a plurality of the target neurons through the synaptic plasticity process,
step g6: during the eighth pre-set period Tk, adjusting the weights of the unidirectional or bidirectional excitatory/inhibitory connections between each activated source neuron and a plurality of the target neurons through the synaptic plasticity process, and
step g7: performing one or more iterations, each time the step g1 to the step g6 is processed is denoted as one iteration.

One or more of the target neurons are mapped to corresponding tags as a result of the information aggregation process of the memory module.

For example, in the information aggregation process, the eighth pre-set period Tk is configured to be 100 ms to 2 seconds, and 10,000 input-side attention control neurons 230 of any one of the composite feature encoding modules 2 are selected as vibrating neurons. Select 10,000 of the concrete feature encoding neurons 210 of the composite feature encoding module 2 as source neurons, and select 10,000 of the abstract feature encoding neurons 220 of the composite feature encoding module 2 as the target neurons.

In this embodiment, the directional information aggregation process of the memory module comprises:
step h1: selecting a plurality of the information input neurons as the vibrating neurons,
step h2: selecting a plurality of the memory neurons as the source neurons,
step h3: selecting a plurality of the memory neurons as the target neurons,
step h4: making each of the vibrating neurons generate activation distribution and maintaining activation of ninth pre-set period Ta,
step h5: during the ninth pre-set period Ta, activating Ma1 of the source neurons and Ma2 of the target neurons,
step h6: during the ninth pre-set period Ta, recording first Ka1 source neuron with the highest activation intensity or the highest firing rate or the first to be excited as Ga1, and recording remaining Ma1-Ka1 activated source neurons as Ga2,
step h7: during the ninth pre-set period Ta, recording the first Ka2 target neurons with the highest activation intensity or the highest firing rate or the first to be excited as Ga3, and recording remaining Ma2-Ka2 activated target neurons as Ga4,
step h8: during the ninth pre-set period Ta, allowing each source neuron in the Ga1 and the unidirectional or bidirectional excitatory/inhibitory connections between a plurality of the target neurons in the Ga3 to perform one or more synaptic weights enhancement processes,
step h9: during the ninth pre-set period Ta, allowing the unidirectional or bidirectional excitatory/inhibitory connections between each source neuron in the Ga1 and a plurality of the target neurons in the Ga4 to perform one or more synaptic weights reduction processes,
step h10: during the ninth pre-set period Ta, allowing each source neuron in the Ga2 and the unidirectional or bidirectional excitatory/inhibitory connections between a plurality of the target neurons in the Ga3 to perform or not to perform once or more times of the synaptic weights reduction processes,
step h11: during the ninth pre-set period Ta, allowing each source neuron in the Ga2 and the unidirectional or bidirectional excitatory/inhibitory connections between a plurality of the target neurons in the Ga4 to perform or not to perform one or more synaptic weights enhancement processes,
step h12: during the ninth pre-set period Ta, allowing each activated vibrating neuron and the unidirectional excitatory/inhibitory connections between the target neurons in the Ga3 to perform once or more times of the synaptic weights enhancement processes,
step h13: during the ninth pre-set period Ta, allowing each activated vibrating neuron and the unidirectional excitatory/inhibitory connections between a plurality of the target neurons in the Ga4 to perform once or more times of the synaptic weights reduction processes, and
step h14: performing one or more iterations, each time the step h1 to the step h13 is performed is denoted as one iteration.

In the process from the step h8 to the step h13, after once or more times of the synaptic weights enhancement processes or the synaptic weights reduction processes are performed, the weights of the input connections or the output connections of part or all of the source neurons or of the target neurons can be standardized or not standardized.

The synaptic weights enhancement processes can adopt a unipolar upstream/downstream activation dependent synaptic enhancement process, or a unipolar spiking time dependent synaptic enhancement process.

The synaptic weights reduction processes can adopt a unipolar upstream/downstream activation dependent synaptic reduction process, or a unipolar spiking time dependent synaptic reduction process.

The synaptic weights enhancement process and the synaptic weights reduction process can also adopt the asymmetric bipolar spiking time dependent synaptic plasticity process or the symmetric bipolar spiking time dependent synaptic plasticity process.

The characterization of each target neuron may be used as a result of the directional information aggregation process of the characterization of each source neuron, and mapped to a corresponding label as an output.

The Ma1 and Ma2 are positive integers, Ka1 is a positive integer not exceeding Ma1, and Ka2 is a positive integer not exceeding Ma2.

For example, let Ma1=100, Ma2=10, Ka1=3, Ka2=2, the ninth pre-set period Ta=200 ms to 2 s, and select 10,000 from input-side attention control neurons 230 as the vibrating neurons, and the 10,000 of the concrete feature encoding neurons 210 of the composite feature encoding module 2 are selected as the source neurons, and 10,000 of the abstract feature encoding neurons 220 of the composite feature encoding module 2 are selected as the target neurons.

Each of the target neurons represents the abstract, isotopic, or concrete representation of the representation of each of the source neurons connected to it. The connection weight of a certain source neuron to each of the target neurons represents the correlation degree between the representation of the source neuron and the representation of each target neuron. The greater the weight, the greater the correlation degree, and vice versa.

For example, when the directional information aggregation process is embodied as a directional information abstraction process, the source neuron represents concrete information (such as a subcategory or instance), and the target neuron represents abstract information (such as a parent category). Each of the target neurons represents the cluster centre of each of the source neurons connected to it (the former represents the common information component in the latter). The connection weight of a source neuron connected to each target neuron represents the correlation degree (or the distance of representation) between the source neuron and the information represented by each target neuron (that is, the cluster centre). The greater the weight, the higher the correlation (i.e., the closer the distance of the representation). The directional information abstraction process is also the clustering process, and is also the meta-learning process.

If the current target neuron is used as the new source neuron, and another group of the memory neuron 80 is selected as the new target neuron, the directional information aggregation process is executed, and such iterations can continuously form a higher level representation of the abstract information.

In this embodiment, the information transcription process comprises:
step f1: selecting a plurality of the neurons as the vibrating neuron,
step f2: selecting a plurality of direct downstream neurons or indirect downstream neurons of the vibrating neurons as the source neurons,
step f3: selecting a plurality of the direct downstream neurons or the indirect downstream neurons of the vibrating neurons as the target neurons,
step f4: making each of the vibrating neurons generate activation distribution and maintain activation for seventh pre-set period Tj,
step f5: during the seventh pre-set period Tj, activating a plurality of the source neurons,
step f6: during the seventh predetermined period Tj, if a certain vibrating neuron is the direct upstream neuron of a certain target neuron, adjusting the weights of the unidirectional or bidirectional excitatory/inhibitory connections between the certain vibrating neuron and the certain target neuron through the synaptic plasticity process, if the certain vibrating neuron is the indirect upstream neuron of a certain target neuron, adjusting unidirectional or bidirectional excitatory/inhibitory connections between the direct upstream neuron of the target neuron and the target neuron in the connections pathway between the certain vibrating neuron and the certain target neuron through the synaptic plasticity process,
step f7: during the seventh pre-set period Tj, if each of the target neurons can establish connections with several other target neurons, adjusting the weights through the synaptic plasticity process, and
step f8: during the seventh pre-set cycle Tj, if there are the unidirectional or bidirectional excitatory connections between a certain source neuron and the certain target neuron, adjusting the weights through the synaptic plasticity process.

For example, in the information transcription process, the seventh pre-set period Tj is configured to be 20 ms to 500 ms, and 10,000 input-side attention control neurons 230 of any one of the composite feature encoding modules 2 are selected as vibrating neurons. Select 10,000 of the concrete feature encoding neurons 210 of the composite feature encoding module 2 as source neurons, and select 10,000 of the abstract feature encoding neurons 220 of the composite feature encoding module 2 as targets neurons.

In the information transcription process, the information represented by part or all of the input to connection weight of each activated source neuron is approximately coupled to part or all of the input connection weight of each target neuron, that is, the information is transcribed from the former into the latter. It is called “approximately coupled” because the transcribed information component is also coupled with the activation distribution of each of the vibrating neurons, the relationship between the vibrating neurons and the activated source neurons, as wells as the influence of the connections and firing conditions of each neuron in the connection path between the vibrating neurons and the target neurons.

Specifically, in the information transcription process, if some activated vibrating neurons are direct upstream neurons of some activated source neurons and of some target neurons, then the connection weights between these vibrating neurons and these source neurons will be added to the connection weights between these vibrating neurons and these target neurons in approximately equal proportions, eventually making the latter approaches the former. On the contrary, if some activated vibrating neurons are upstream neurons of some activated source neurons or indirect some target neurons, then the connection weights of these vibrating neurons and these target neurons will eventually include the influence of the connection pathway between the vibrating neurons and the activated source neurons, and the connection and distribution of each neuron in the connection pathway between the vibrating neurons and the target neurons.

In this embodiment, the memory forgetting process comprises an upstream distribution dependent memory forgetting process, a downstream distribution dependent memory forgetting process, and an upstream and downstream distribution dependent memory forgetting process.

The upstream distribution dependent memory forgetting process comprises: for a certain connection, if its upstream neuron continues to not distribute within fourth pre-set period (such as 20 minutes to 24 hours), absolute value of the weights is reduced, and the reduced amount is denoted as DwDecay1.

The downstream distribution dependent memory forgetting process comprises: for the certain connection, if its downstream neuron continues to not distribute within fifth pre-set period (such as 20 minutes to 24 hours), the absolute value of the weights is reduced, and the reduced amount is denoted as DwDecay2.

The upstream and downstream distribution dependent memory forgetting process comprises: for the certain connection, if its upstream and downstream neurons do not perform synchronous distribution during sixth pre-set period (such as 20 minutes to 24 hours), the absolute value of the weights is reduced, and the reduced amount is denoted as DwDecay3.

The synchronous distribution comprises: when the downstream neuron involved in the connections activates, and time interval from current or past most recent upstream neuron activation does not exceed fourth pre-set time interval Te1, or when the upstream neuron involved in the connections activates, and the time interval from the current or past most recent downstream neuron activation does not exceed the fifth pre-set time interval Te2.

For example, let the fourth pre-set time interval Te1=30 ms, and the fifth pre-set time interval Te2=20 ms.

In the memory forgetting process, if the certain connection has a specified lower limit of the absolute value of the weights, the absolute value of the weights will no longer decrease when the absolute value of the weights reaches the lower limit, or the connections will be cut off.

In this embodiment, the DwDecay1, the DwDecay2, and the DwDecay3 are respectively proportional to the weights of the connections involved. For example, DwDecay1=Kdecay1*weight, DwDecay2=Kdecay2*weight, DwDecay1=Kdecay3*weight. Let Kdecay1=Kdecay2=Kdecay3=0.01, and weight is the connection weight.

In this embodiment, the memory self-consolidation process comprises: when a certain neuron is spontaneous firing, the weights of part or all of the certain neuron is adjusted through a unipolar downstream activation dependent synaptic enhancement process and a unipolar downstream spiking dependent synaptic enhancement process, the weights of part or all of output connections of the certain neuron are adjusted through a unipolar upstream activation dependent synaptic enhancement process and a unipolar upstream spiking dependent synaptic enhancement process.

The memory self-consolidation process helps to maintain the codes of some of the neurons to with approximate fidelity and avoid forgetting.

In this embodiment, the information component adjustment process of the brain-like neural network comprises:
step i1: selecting a plurality of the neurons as the vibrating neurons,
step i2: selecting a plurality of direct downstream neurons or indirect downstream neurons of the vibrating neurons as the target neurons,
step i3: making each of the vibrating neurons generate activation distribution, and maintaining activation of each vibrating neuron during first pre-set period Tb,
step i4: during the first pre-set period Tb, activating Mb1 of the target neurons, first Kb1 target neurons with the highest activation intensity or the highest firing rate or the first to be excited are recorded as Gb1, and remaining Mb1-Kb1 activated target neurons are recorded as Gb2,
step i5: if a certain vibrating neuron is a direct upstream neuron of a certain target neuron in the Gb1, making the unidirectional or bidirectional connections between the certain vibrating neuron and the certain target neuron to perform one or more synaptic weights enhancement processes, and if the certain vibrating neuron is an indirect upstream neuron of the certain target neuron in the Gb1, then making the unidirectional or bidirectional connections, which are between the certain target neuron and the direct upstream neuron of said certain target neuron, in the connections paths between the certain vibrating neuron and the certain target neuron to perform once or more times of the synaptic weights enhancement processes,
step i6: if the certain vibrating neuron is the direct upstream neuron of the certain target neuron in the Gb2, making the unidirectional or bidirectional connections between the certain vibrating neuron and the certain target neuron perform once or more times of the synaptic weights reduction processes, and if the vibrating neuron is the indirect upstream neuron of the certain target neuron in the Gb2, then making the unidirectional or bidirectional connections, which are between the certain target neuron and the direct upstream neuron of said certain target, in the connections paths between the certain vibrating neuron and the certain target neuron perform once or more times of the synaptic weights reduction processes, and
step i7: performing one or more iterations, each time that the step i1 to the step i6 is performed is denoted as one iteration.

In the process of the step i5 and the step i6, after performing once or more times of the synaptic weights enhancement processes or the synaptic weights reduction processes, the weights of part or all of the input connections of each target neuron can be standardized or not.

A number of the target neurons can be mapped to corresponding labels as a result of the information component adjustment process.

The synaptic weights enhancement processes can adopt a unipolar upstream/downstream activation dependent synaptic enhancement process, or a unipolar spiking time dependent synaptic enhancement process.

The synaptic weights reduction processes can adopt a unipolar upstream/downstream activation dependent synaptic reduction process, or a unipolar spiking time dependent synaptic reduction process.

The synaptic weights enhancement process and the synaptic weights reduction process can also adopt the asymmetric bipolar spiking time dependent synaptic plasticity process or the symmetric bipolar spiking time dependent synaptic plasticity process.

When the Kb1 takes a small value (for example 1), only the target neurons with the highest activation intensity or the highest firing rate or the first firing will undergo the synaptic weight enhancement process, namely superimpose information components represented by each vibrating neuron's current firing in a certain degree, making the target neurons to consolidate its existing representation. The other target neurons all undergo the synaptic weight reduction process, that is, to a certain extent subtract (decouple) the information components represented by the current firing of each vibrating neuron. Therefore, multiple iterations are performed, and each iteration causes each of the vibrating neurons to produce a different activation distribution, which can make the representation of each target neuron be decoupled from each other. If further iterations are performed to strengthen the decoupling, the representations of each target neuron will become a set of relatively independent bases in the representation space.

In the same way, when the Kb1 takes a larger value (for example 8), multiple iterations are performed, and each iteration causes each vibrating neuron to produce a different activation distribution, which can make the information components represented by multiple target neurons be superimposed on each other to a certain extent. If further iterations are performed, the representations of multiple target neurons can be close to each other.

Therefore, adjusting the Kb1 can adjust the information component represented by each target neuron.

For example, in the information component adjustment process, the first pre-set period Tb is configured to be 100 ms to 500 ms, and 10,000 input-side attention control neurons 230 of any one of the composite feature encoding modules 2 are selected as vibrating neurons, and select 10,000 of the concrete feature encoding neurons 210 of the composite feature encoding module 2 as target neurons.

In this embodiment, the reinforcement learning process comprises: when a plurality of the connections receive a reinforcement signal, in the second pre-set potential, the weights of the connections change, or the weights reduction of connections changes, or the weights increase/reduction of the connections in the synaptic plasticity process changes.

Or, when one or more of the neurons receive the reinforcement signal, in the third pre-set potential (for example, within 30 seconds from the time the reinforcement signal is received), the neurons receive positive or negative input, or the weights of part or all of the input connections or output connections of these neurons change, or the weights reduction of the connections in the memory forgetting process changes, or the weights increase/reduction of the connections in the synaptic plasticity process change.

In this embodiment, the reinforcement signal is a constant value when the brain-like visual neural network has no input information, in the supervised learning process, if the result of the memory triggering process is correct, the reinforcement signal rises, if the result of the memory triggering process is wrong, then the reinforcement signal drops.

For example, if the constant value of the reinforcement signal is 0, if the supervised learning process is performed, the result of the memory triggering process is correct, the reinforcement signal rises to +10, and the bidirectional excitatory connection between several concrete features encoding neurons 210 receives the reinforcement signal (+10), During the second pre-set time interval (within 30 seconds from the time of receiving the reinforcement signal), the DwLTP6 is incremented by 10 to its original value if these connections undergo the symmetrical bipolar pulse time-dependent synaptic plasticity process.

In this embodiment, the novelty signal modulation process comprises: when a plurality of the neurons receive the novelty signal, in sixth pre-set time interval (for example, within 30 seconds starting from receiving the novelty signal), said plurality of the neurons receive positive or negative input, or the weights of part or all of input connections or output connections of said plurality of the neurons change, or the weights reduction of the connections in the memory forgetting process change, or the weight increase/reduction of the connections in the synaptic plasticity process change.

In this embodiment, when the brain-like visual neural network has no input information, the novelty signal is a constant value or gradually decreases with time, when the brain-like visual neural network has input information, the novelty signal is negatively correlated with the activation intensity or firing rate of each neuron in the target region during the memory triggering process.

For example, when there is no input information, the novelty signal is a constant value of +50. Apply input information (image or video). If these inputs do not trigger memory information of sufficient relevance (for example, if the neurons in the target area have only 10% of the maximum activation of the current image compared to the maximum activation of the image encoded in the memory), the novelty signal will increase from constant +50 to +90.

When several of the neurons constituting the forward neural pathway receive a novelty signal of +90, these neurons receive a positive input (such as +40) in the sixth pre-set time interval.

When several of the neurons constituting the reverse neural pathway receive a novelty signal of +90, these neurons receive a negative input (such as −40) in the sixth pre-set time interval.

When the input information remains unchanged and the forward-learning process is performed, if the highest activation intensity of the neurons in the target area is 90%, the novelty signal decreases from +90 to +10.

When several of the neurons constituting the positive neural pathway receive a novelty signal of +10, these neurons receive a negative input (such as −40) in the sixth pre-set time interval.

When several of the neurons constituting the reverse neural pathway receive a novelty signal of +10, these neurons receive a positive input (such as +40) in the sixth pre-set time interval.

Therefore, when a sufficiently novel external input information is presented, the novelty signal will make the neurons in the forward neural pathway receive positive input (excitability enhancement) and be more easily activated, while the neurons in the reverse neural pathway receive negative input (excitability reduction) and be more difficult to activate. Then, the neural network preferentially pays attention to, recognizes and learns the current novel external input information through the bottom-up forward neural pathway. On the other hand, when the external input information is not novel, said novelty signal will make positive neural pathways neurons receive negative input (excitatory abate) and more difficult to activate, and make the reverse neural pathways at a neuron receives input (excitability enhancement) and easier to activate, so that neural network first the by top-down reverse neural pathways triggered both memory information, or the whole process of pattern completion, association or imagination.

In this embodiment, the supervised learning process comprises:
step r1: giving positive activation distribution range of each neuron in the target area, giving negative activation distribution range of each neuron in the target area, and then performing step r2,
step r2: performing the memory triggering process, if actual activation distribution of each neuron in the target area does not conform to the positive activation distribution range or the negative activation distribution range, it is regarded as each neuron in the target area does not encode relevant memory information, and performing step R3, if the actual distribution of each neuron in the target area conforms to the positive distribution range, the result of the memory triggering process is regarded as correct, and the supervised learning process is ended, if the actual release distribution of each neuron in the target area conforms to the negative activation distribution range, the result of the memory triggering process is regarded as an error, and performing step r3,
step r3: performing one or more of the novelty signal modulation process, the reinforcement learning process, the active attention process, the automatic attention process, the directional start process, the forward-learning process, the information aggregation process, the directional information aggregation process, the information component adjustment process, the information transcription process and the differential information decoupling process, so that each neuron in the target area encodes the relevant memory information, and performing step r1.

The supervised learning process can also comprise:
step q1: giving positive label range, and giving negative label range, and performing q2,
step q2: performing the memory triggering process, and mapping the actual activation distribution of each neuron in the target area to corresponding label, if the corresponding label does not meet the positive label range nor the negative label range, it is regarded as each neuron in the target area does not encode the relevant memory information, then perming step q3, if the corresponding label meets the positive label range, the result of the memory triggering process is deemed correct, and the supervised learning process is ended, if the corresponding label meets the negative label range, the result of the memory triggering process is regarded as an error, and then performing step q3,
step q3: performing one or more of the novelty signal modulation process, the reinforcement learning process, the active attention process, the automatic attention process, the directional start process, the forward-learning process, the information aggregation process, the directional information aggregation process, the information component adjustment process, and the information transcription process and the differential information decoupling process, so that each neuron in the target area encodes relevant memory information, and then performing the step q1.

In this embodiment, the unipolar upstream activation dependent synaptic plasticity process comprises a unipolar upstream activation dependent synaptic enhancement process and a unipolar upstream activation dependent synaptic reduction process.

The unipolar upstream activation dependent synaptic enhancement process comprises: when the activation intensity or firing rate of the upstream neurons involved in the connections is not zero, the absolute value of weights of the connections will be increased, and the increment is denoted as DwLTP1u.

The unipolar upstream activation dependent synaptic reduction process comprises: when the activation intensity or firing rate of the upstream neurons involved in the connections is not zero, the absolute value of the weights of the connections will be reduced, the reduction is denoted as DwLTD1u.

DwLTP1u and DwLTD1u are non-negative values.

In this embodiment, the values of DwLTP1u and DwLTD1u in the unipolar upstream activation dependent synaptic plasticity process comprises one or more of:
DwLTP1u and DwLTD1u are non-negative and are respectively proportional to the activation intensity or activation rate of the upstream neurons in the involved connections, or
DwLTP1u and DwLTD1u are non-negative values and are respectively proportional to the activation intensity or activation rate of the upstream neurons involved in the connections and the weights of the involved connections.

For example, let DwLTP1u=0.01*Fru1, DwLTD1u=0.01*Fru1, and Fru1 is the firing rate of the upstream neurons.

In this embodiment, the unipolar downstream activation dependent synaptic plasticity process comprises a unipolar downstream activation dependent synaptic enhancement process and a unipolar downstream activation dependent synaptic reduction process.

The unipolar downstream activation dependent synaptic enhancement process comprises: when the activation intensity or firing rate of the downstream neurons involved in the connections is not zero, the absolute value of weights of the connections is increased, and the increment is denoted as DwLTP1d.

The unipolar downstream activation dependent synaptic reduction process comprises: when the activation intensity or firing rate of the downstream neurons involved in the connections is not zero, the absolute value of the weights of the connections will be reduced, the reduction is denoted as DwLTD1d.

DwLTP1d and DwLTD1d are non-negative values.

In this embodiment, the values of DwLTP1d and DwLTD1d in the unipolar downstream activation dependent synaptic plasticity process comprises one or more of:
DwLTP1d and DwLTD1d are non-negative and are respectively proportional to the activation intensity or activation rate of the downstream neurons in the involved connections, or
DwLTP1u and DwLTD1u are non-negative and are respectively proportional to the activation intensity or activation rate of the downstream neurons involved in the connections and the weights of the involved connections.

For example, let DwLTP1d=0.01*Frd1, DwLTD1d=0.01*Frd1, and Frd1 is the firing rate of downstream neurons.

In this embodiment, the unipolar upstream and downstream activation dependent synaptic plasticity process comprises a unipolar upstream and downstream activation dependent synaptic enhancement process and a unipolar upstream and downstream activation dependent synaptic reduction process.

The unipolar upstream and downstream activation dependent synaptic enhancement process comprises: when the activation intensity or firing rate of the upstream and downstream neurons involved in the connections is not zero, the absolute value of weights of the connections will be increased, and the increment is denoted as DwLTP2.

The unipolar upstream and downstream activation dependent synaptic reduction process comprises: when the activation intensity or firing rate of the upstream and downstream neurons involved in the connections is not zero, the absolute value of the weights of the connections will be reduced, the reduction is denoted as DwLTD2.

DwLTP2 and DwLTD2 are non-negative values.

In this embodiment, the values of DwLTP2 and DwLTD2 in the unipolar upstream and downstream activation dependent synaptic plasticity comprises one or more of:
DwLTP2 and DwLTD2 are non-negative, are respectively proportional to the activation intensity or activation rate of the upstream neurons and the activation intensity or activation rate of the upstream neurons, or
DwLTP2 and DwLTD2 are non-negative, are respectively proportional to the activation intensity or activation rate of the downstream neurons involved in the connections, the activation intensity or activation rate of the upstream neurons in the involved connections, and the weights of the involved connections.

For example, let DwLTP2=0.01*Fru2*Frd2, DwLTD2=0.01*Fru2*Frd2, and Fru2 and Frd2 are the firing rates of upstream and downstream neurons, respectively.

In this embodiment, the unipolar upstream spiking dependent synaptic plasticity process comprises a unipolar upstream spiking dependent synaptic enhancement process and a unipolar upstream spiking dependent synaptic reduction process.

The unipolar upstream spiking dependent synaptic enhancement process comprises: when the upstream neurons involved in the connections activates, the absolute value of weights of the connections will be increased, and the increment is denoted as DwLTP3u.

The unipolar upstream spiking dependent synaptic reduction process comprises: when the upstream neurons involved in the connections activates, the absolute value of the weights of the connections will be reduced, the reduction is denoted as DwLTD3u.

DwLTP3u and DwLTD3u are non-negative values.

The values of DwLTP3u and DwLTD3u in the unipolar upstream spiking dependent synaptic plasticity process comprises one or more of:
DwLTP3u and DwLTD3u are non-negative constants, or
DwLTP3u and DwLTD3u are non-negative, are respectively proportional to the weights of the involved connections.

For example, let DwLTP3u=0.01*weight, DwLTD3u=0.01*weight, and weight is the connection weight.

In this embodiment, the unipolar downstream spiking dependent synaptic plasticity process comprises a unipolar downstream spiking dependent synaptic enhancement process and a unipolar downstream spiking dependent synaptic reduction process.

The unipolar upstream spiking dependent synaptic enhancement process comprises: when the upstream neurons involved in the connections activates, the absolute value of weights of the connections will be increased, and the increment is denoted as DwLTP3d.

The unipolar upstream spiking dependent synaptic reduction process comprises: when the upstream neurons involved in the connections activates, the absolute value of the weights of the connections will be reduced, the reduction is denoted as DwLTD3d.

DwLTP3d and DwLTD3d are non-negative values.

In this embodiment, the values of DwLTP3d and DwLTD3d in the unipolar downstream spiking dependent synaptic plasticity process s comprises one or more of:
DwLTP3d and DwLTD3d are non-negative constants, or
DwLTP3d and DwLTD3d are non-negative, and are respectively proportional to the weights of the involved connections.

For example, let DwLTP3d=0.01*weight, DwLTD3d=0.01*weight, and weight is the connection weight.

In this embodiment, the unipolar spiking time dependent synaptic plasticity process comprises a unipolar spiking time dependent synaptic enhancement process and unipolar spiking time dependent synaptic reduction process.

The unipolar spiking time dependent synaptic enhancement process comprises: when the upstream neurons involved in the connections activates, and the time interval from the current or past most recent upstream neurons firing is no more than Tg1, or when the downstream neurons involved in the connections activates, the time interval from the current or past most recent downstream neuron firing is no more than Tg2, the absolute value of weights of the connections will be increased, and the increment is denoted as DwLTP4.

The unipolar spiking time dependent synaptic reduction process comprises: when the downstream neurons involved in the connections activates, and the time interval from the current or past most recent downstream neurons firing is no more than Tg3, or when the downstream neurons involved in the connections activates, the time interval from the current or past most recent downstream neuron firing is no more than Tg4, the absolute value of the weights of the connections will be reduced, the reduction is denoted as DwLTD4.

DwLTP4 and DwLTD4 are non-negative values, and the Tg1, Tg2, Tg3, and Tg4 are all non-negative values. For example, set Tg1, Tg2, Tg3, and Tg4 to 200 ms.

In this embodiment, the values of DwLTP4 and DwLTD4 in the unipolar spiking time dependent synaptic plasticity process comprises one or more of:
DwLTP4 and DwLTD4 are non-negative constants, or
DwLTP4 and DwLTD4 are non-negative, and are respectively proportional to the weights of the involved connections.

For example, let DwLTP4=KLTP4*weight+C1, DwLTD4=KLTD4*weight+C2, where KLTP4=0.01 is the proportional coefficient of the synaptic enhancement process, KLTD4=0.01, is the proportional coefficient of the synaptic weakening process, C1 and C2 are Constant, and set to 0.001.

In the embodiment, the asymmetric bipolar spiking time dependent synaptic plasticity process comprises:
when the downstream neurons involved in the connections activates, if the time interval from the current or past most recent downstream neurons firing is no more than Th1, the absolute value of the weights will be increased, and the increment is denoted as DwLTP5, if the time interval from the current or past most recent upstream neurons firing is more than Th1 but is no more than Th2, the absolute value of the weights of the connections will be reduced, the reduction is denoted as DwLTD5, or when the upstream neurons involved in the connections activates, if the time interval from the current or past most recent upstream neurons firing is no more than Th3, then the absolute value of the weights will be increased, and the increment is denoted as DwLTP5, if the time interval from the current or past most recent downstream neurons firing is more than Th3 but is no more than Th4, the absolute value of the weights of the connections will be reduced, the reduction is denoted as DwLTD5.

Th1, Th3, DwLTP5 and DwLTD5 are non-negative, Th2 is a value greater than Th1, and Th4 is a value greater than Th3. For example, let Th1=Th3=150 ms, Th2=Th4=200 ms.

In this embodiment, the values of DwLTP5 and DwLTD5 in the asymmetric bipolar spiking time dependent synaptic plasticity process comprises one or more of:
DwLTP5 and DwLTD5 are non-negative constants, or
DwLTP5 and DwLTD5 are non-negative, and are respectively proportional to the weights of the involved connections, for example, let DwLTP5=KLTP5*weight, DwLTD5=KLTD5*weight, such as let KLTP5=0.01 and KLTD5=0.01, or DwLTP5 and DwLTD5 are non-negative, DwLTP5 is negatively correlated with the time interval between downstream neurons and the upstream neurons, specifically, when the time interval is 0, DwLTP5 reaches specified maximum value DwLTPmax5, and when the time interval is Th1, DwLTP5 is 0. DwLTD5 is negatively correlated with the time interval between the downstream neurons and the upstream neurons, when the time interval is Th1, DwLTD5 reaches specified maximum value DwLTDmax5, and when the time interval is Th2, DwLTD5 is 0. For example, let DwLTPmax5=0.1, DwLTDmax5=0.1, Let DwLTP5=−DwLTPmax5/Th1*DeltaT1+DwLTPmax5, let DwLTD5=−DwLTDmax5/(Th2−Th1)*DeltaT1+DwLTDmax5*Th2/(Th2−Th1).

DeltaT1 is the time interval between downstream neuron and upstream neuron firing (that is, the time when the downstream neuron fires minus the time when the upstream neuron fires).

In this embodiment, the symmetric bipolar spiking time dependent synaptic plasticity process comprises:
when the downstream neurons involved in the connections activates, if the time interval from the current or past most recent downstream neurons firing is no more than Ti1, the absolute value of the weights of the connections will be increased the increase is denoted as DwLTP6,
if the time interval from the current or past most recent downstream neurons firing is more than Th1 but is no more than Ti2, the absolute value of the weights of the connections will be reduced, the reduction is denoted as DwLTD6/Th1, Th2, DwLTP6 and DwLTD6 are non-negative. For example, let Ti1=200 ms and Ti2=200 ms.

In this embodiment, the values of DwLTP6 and DwLTD6 in the symmetric bipolar spiking time dependent synaptic plasticity process comprises one or more of:
DwLTP6 and DwLTD6 are non-negative constants, or
DwLTP6 and DwLTD6 are non-negative, and are respectively proportional to the weights of the involved connections, for example, let DwLTP6=KLTP6*weight, DwLTD6=KLTD6*weight, such as KLTP6=0.01, KLTD6=0.01, and weight as the connection weight, or
DwLTP6 and DwLTD6 are non-negative, DwLTP6 is negatively correlated with the time interval between downstream neurons and the upstream neurons, specifically, when the time interval is 0, DwLTP6 reaches specified maximum value DwLTPmax6, and when the time interval is Ti1, DwLTP6 is 0. DwLTD6 is negatively correlated with the time interval between the downstream neurons and the upstream neurons, when the time interval is Ti1, DwLTD6 reaches specified maximum value DwLTDmax6, and when the time interval is Ti2, DwLTD6 is 0, for example, let DwLTPmax6=0.1, DwLTDmax6=0.1, let DwLTP6=−DwLTPmax6/DeltaT2+DwLTPmax6, DwLTD6=−DwLTDmax6/DeltaT3+DwLTDmax6, DeltaT2 is the time interval between downstream and upstream neurons, and DeltaT3 is the time between upstream and downstream neurons.

The various embodiments in this specification are in a progressive manner. Each embodiment focuses on the differences from other embodiments, and the same or similar parts between the various embodiments can be referred to each other. For the device disclosed in the embodiment, since it corresponds to the method disclosed in the embodiment, the description is relatively simple, and the relevant part can be referred to the description of the method part.

The foregoing description of the disclosed embodiments enables those skilled in the art to implement or use the present invention. Various modifications to these embodiments will be obvious to those skilled in the art, and the general principles defined herein can be implemented in other embodiments without departing from the spirit or scope of the present invention. Therefore, the present invention will not be limited to the embodiments shown in this document, but should conform to the widest scope consistent with the principles and novel features disclosed in this application.

What is claimed is:

1. A brain-like visual neural network with forward-learning and meta-learning functions, comprising: a plurality of primary feature encoding modules and a plurality of composite feature encoding modules,
wherein the primary feature encoding modules and the composite feature encoding modules each comprises a plurality of neurons,
wherein the plurality of the neurons comprises a primary feature encoding neuron, a concrete feature encoding neuron, and an abstract feature encoding neuron, wherein each primary feature encoding module comprises a plurality of the primary feature encoding neurons for encoding primary visual feature information, wherein each composite feature encoding module comprises a concrete feature encoding unit and an abstract feature encoding unit,
wherein the concrete feature encoding unit comprises a plurality of the concrete feature encoding neurons for encoding concrete visual feature information,
wherein the abstract feature encoding unit comprises a plurality of the abstract feature encoding neurons for encoding abstract visual feature information,
wherein a plurality of the primary feature encoding neurons respectively form unidirectional or bidirectional excitatory/inhibitory connections with a plurality of other said primary feature encoding neurons,
wherein a plurality of the primary feature encoding neurons and a plurality of the concrete feature encoding neurons or a plurality of the abstract feature encoding neurons located in at least one of the composite feature encoding modules respectively form the unidirectional or bidirectional excitatory/inhibitory connections,
wherein a plurality of the concrete feature encoding neurons located in a same composite feature encoding module and a plurality of the abstract feature encoding neurons located in the same composite feature encoding module respectively form the unidirectional or bidirectional excitatory/inhibitory connections,
wherein a plurality of the concrete feature encoding neurons and the abstract feature encoding neurons in a plurality of the composite feature encoding modules respectively form the unidirectional or bidirectional excitatory/inhibitory connections with a plurality of the concrete feature encoding neurons and the abstract feature encoding neurons of a plurality of other composite feature encoding modules.

2. A brain-like visual neural network with forward-learning and meta-learning functions according to claim 1,
wherein the brain-like visual neural network buffers and encodes information through firing of the neurons, and encodes, stores, and transmits information through the unidirectional or bidirectional excitatory/inhibitory connections between the neurons,
wherein an image or a video stream is input, and a plurality of pixel values of a plurality of pixels of each frame of the image are respectively multiplied by weights and input to a plurality of the primary feature encoding neurons, so as to activate a plurality of the primary feature encoding neurons,
wherein for a plurality of the neurons, membrane potential is calculated to determine whether to fire, if the neurons are activated, each downstream neuron will accumulate the membrane potential, and then determine whether to fire, so that the firing will propagate in the brain-like visual neural network, wherein weights of connections between upstream neurons and the downstream neurons are constant or dynamically adjusted through synaptic plasticity,
wherein a plurality of the neurons are mapped to corresponding labels as output.

3. A brain-like visual neural network with forward-learning and meta-learning functions according to claim 2,
wherein working process of the brain-like visual neural network comprises at least one of: forward memorization process, memory triggering process, information aggregation process, directional information aggregation process, information transcription process, memory forgetting process, memory self-consolidation process, information component adjustment process, reinforcement learning process, novelty signal modulation process and supervised learning process.

4. A brain-like visual neural network with forward-learning and meta-learning functions according to claim 3,
wherein synaptic plasticity process comprises: unipolar upstream firing dependent synaptic plasticity process, unipolar downstream firing dependent synaptic plasticity process, unipolar upstream and downstream firing dependent synaptic plasticity process, unipolar upstream spiking dependent synaptic plasticity process, unipolar downstream spiking dependent synaptic plasticity process, unipolar spiking time dependent synaptic plasticity process, asymmetric bipolar spiking time dependent synaptic plasticity process, symmetric bipolar spiking time dependent synaptic plasticity process.

5. A brain-like visual neural network with forward-learning and meta-learning functions according to claim 1, wherein a plurality of the neurons adopt spiking neurons or non-spiking neurons.

6. A brain-like visual neural network with forward-learning and meta-learning functions according to claim 1, wherein a plurality of neurons of the brain-like visual neural network are spontaneous firing neurons, and the spontaneous firing neurons comprise conditionally spontaneous firing neurons and unconditionally spontaneous firing neurons,
wherein if the conditionally spontaneous firing neurons are not fired by external input in first pre-set time interval, the conditionally spontaneous firing neurons will self-fire according to probability P,
wherein membrane potential of the unconditionally spontaneous firing neurons accumulates automatically and gradually without the external input, when the membrane potential reaches a threshold, the unconditionally spontaneous firing neurons fire, and the membrane potential is restored to resting potential to restart accumulation process.

7. A brain-like visual neural network with forward-learning and meta-learning functions according to claim 1, wherein a plurality of the connections of the brain-like visual neural network can be replaced by convolution operations.

8. A brain-like visual neural network with forward-learning and meta-learning functions according to claim 1, wherein the composite feature encoding module further comprises an input-side attention control unit and an output-side attention control unit,
wherein the neurons further comprise an input-side attention control neuron and an output-side attention control neuron,
wherein the input-side attention control unit comprises a plurality of the input-side attention control neurons,
wherein the output-side attention control unit comprises a plurality of the output-side attention control neurons,
wherein the input attention control neuron can receive the unidirectional or bidirectional excitatory/inhibitory connections of the primary feature encoding neurons respectively,
wherein each of the input-side attention control neurons forms unidirectional or bidirectional excitatory connections with a plurality of the concrete feature encoding neurons or a plurality of the abstract feature encoding neurons of the composite feature encoding module,
wherein each of the input-side attention control neurons forms the unidirectional or bidirectional excitatory connections with a plurality of the concrete feature encoding neurons or a plurality of the abstract feature encoding neurons or a plurality of the output-side attention control neurons from said other composite feature encoding modules,
wherein each input-side attention control neuron can also form the unidirectional or bidirectional excitatory connections with a plurality of other input-side attention control neurons,
wherein each input-side attention control neuron can also form the unidirectional or bidirectional excitatory connections with a plurality of the other input-side attention control neurons,
wherein each of the output-side attention control neurons forms unidirectional or bidirectional excitatory connections with a plurality of the concrete feature encoding neurons or a plurality of the abstract feature encoding neurons or a plurality of the input-side attention control neurons located in said other composite feature encoding modules,
wherein each of the output-side attention control neurons receives the unidirectional or bidirectional excitatory connections from a plurality of the concrete feature encoding neurons or a plurality of the abstract feature encoding neurons from the composite feature encoding module where said each of the output-side attention control neurons is located,
wherein each of the output-side attention control neurons can also form the unidirectional or bidirectional excitatory connections with a plurality of other output-side attention control neurons.

9. A brain-like visual neural network with forward-learning and meta-learning functions according to claim 8,
wherein each of the input-side attention control neurons can have an input-side attention control end, each of the output-side attention control neurons can have an output-side attention control end,
wherein the working process of the brain-like visual neural network further comprises active attention process and automatic attention process,
wherein the active attention process comprises: adjusting activation intensity or firing rate or spiking firing phase of each input-side attention control neuron through adjusting strength of attention control signal applied at the input-side attention control end, thereby controlling the information entering corresponding concrete feature encoding units and corresponding abstract feature encoding units, and adjusting size and proportion of each information component, or adjusting the activation intensity or the firing rate or the spiking firing phase of each output-side attention control neuron by adjusting the strength of the attention control signal applied at the output side attention control end, thereby controlling information output from the corresponding concrete feature encoding units and the corresponding abstract feature encoding units, and adjusting the size and proportion of each information component,
wherein the automatic attention process comprises: when a plurality of the neurons connected to the input-side attention control neurons are activated, making the input-side attention control neurons more easily activated, so that relevant information components are more easily input to the corresponding concrete feature encoding units and the corresponding abstract feature encoding unit, or, when a plurality of the neurons connected to the output-side attention control neurons are activated, making the output-side attention control neurons more easily activated, so that the relevant information components are more easily output from the corresponding concrete feature encoding units and the corresponding abstract feature encoding units.

10. A brain-like visual neural network with forward-learning and meta-learning functions according to claim 1, wherein the brain-like visual neural network comprises one or more information channels,
wherein the working process of the brain-like visual neural network further comprises information channel automatic formation process,
wherein the information channel automatic formation process comprises: adjusting connection relationship and weights between the neurons by performing one or more of the forward memorization process, the memory triggering process, the information aggregation process, the directional information aggregation process, the information transcription process, the memory forgetting process, the memory self-consolidation process and the information component adjustment process, so that the brain-like visual neural network forms said one or more information channels, and each information channel encodes one or more information components, wherein there can be crossover between the information channel,
wherein the neural network can also form said one or more information channels by pre-setting initial connection relationship and initial parameters, and wherein each information channel encodes one or more pre-set information components.

11. A brain-like visual neural network with forward-learning and meta-learning functions according to claim 10, wherein the information channels comprise primary information channels,
wherein the primary information channel is: all the primary feature encoding neurons' connections constitute the primary information channels,
wherein the primary information channels comprise primary contrast information channels, primary orientation information channels, primary edge information channels, and primary colour block information channels,
wherein the primary contrast information channels are formed by: selecting a plurality of adjacent pixels in input image as central area pixels, selecting a plurality of the pixels around the central area pixels as surrounding area pixels, and multiplexing a plurality of pixel values of the central region pixels and the surrounding region pixels by the weights and input to a plurality of the primary feature encoding neurons, i.e., forming a central-surrounding topology structure, wherein the feature encoding neurons and the feature encoding neurons' connections form one or more said primary contrast information channels,
wherein in the primary information channels, one or more similar pixels with similar numbers, locations of image space covered by similar pixels and areas of the image space covered by the similar pixels are selected, wherein one or more of the pixel values of said similar pixels are respectively multiplied by one or more of the weights, wherein one or more of the primary orientation information channels, the primary edge information channels, the primary colour block information channels or synthesis thereof that are with one or more receptive fields can be formed.

12. A brain-like visual neural network with forward-learning and meta-learning functions according to claim 11,
wherein the primary contrast information channels comprise light-dark contrast information channels, dark-light contrast information channels, red-green contrast information channels, green-red contrast information channels, yellow-blue contrast information channels, and blue-yellow contrast information channels,
wherein the light-dark contrast information channels are formed by: respectively multiplying R, G, and B pixel values of each central area pixel by positive weights and inputting to a plurality of the primary feature encoding neurons, and respectively multiplying the R, G, and B pixel values of each surrounding area pixel by negative weights and inputting to a plurality of the primary feature encoding neurons, wherein the primary feature encoding neurons and the primary feature encoding neurons' connections form the light-dark contrast information channels,
wherein the dark-light contrast information channels are formed by: respectively multiplying the R, G, and B pixel values of each central area pixel by the negative weights and inputting to a plurality of the primary feature encoding neurons, and respectively multiplying the R, G, and B pixel values of each surrounding area pixel by the positive weights and inputting to a plurality of the primary feature encoding neurons,
wherein the primary feature encoding neurons and the primary feature encoding neurons' connections form the dark-light contrast information channels,
wherein the red-green contrast information channels are formed by: respectively multiplying the R, G, and B pixel values of each central area pixel by the positive weights, the negative weights and the positive weights and inputting to a plurality of the primary feature encoding neurons, and respectively multiplying the R, G, and B pixel values of each surrounding area pixel by the negative weights, the positive weights and the positive weights and inputting to a plurality of the primary feature encoding neurons, wherein the primary feature encoding neurons and the primary feature encoding neurons' connections form the red-green contrast information channels,
wherein the green-red contrast information channels are formed by: respectively multiplying the R, G, and B pixel values of each central area pixel by the negative weights, the positive weights and the positive weights and inputting to a plurality of the primary feature encoding neurons, and respectively multiplying the R, G, and B pixel values of each surrounding area pixel by the positive weights, the negative weights and the positive weights and inputting to a plurality of the primary feature encoding neurons,
wherein the primary feature encoding neurons and the primary feature encoding neurons' connections form the red-green contrast information channels,
wherein the yellow-blue contrast information channels are formed by: respectively multiplying the R, G, and B pixel values of each central area pixel by the positive weights, the positive weights and the negative weights and inputting to a plurality of the primary feature encoding neurons, and respectively multiplying the R, G, and B pixel values of each surrounding area pixel by the negative weights, the negative weights and the positive weights and inputting to a plurality of the primary feature encoding neurons, wherein the primary feature encoding neurons and the primary feature encoding neurons' connections form the yellow-blue contrast information channels, and
wherein the blue-yellow contrast information channels are formed by: respectively multiplying the R, G, and B pixel values of each central area pixel by the negative weights, the negative weights and the positive weights and inputting to a plurality of the primary feature encoding neurons, and respectively multiplying the R, G, and B pixel values of each surrounding area pixel by the positive weights, the positive weights and the negative weights and inputting to a plurality of the primary feature encoding neurons, wherein the primary feature encoding neurons and the primary feature encoding neurons' connections form the blue-yellow contrast information channels.

13. A brain-like visual neural network with forward-learning and meta-learning functions according to claim 11, wherein the primary information channels comprise primary optical flow information channels,
wherein the primary optical flow information channels are formed by: calculating optical flow of a plurality of the pixels in the input image respectively to obtain direction value and speed value of movement of the optical flow, combining different direction values and speed values, and respectively multiplying the weights and inputting to a plurality of said primary feature encoding neurons, wherein the primary feature encoding neurons and the primary feature encoding neurons' connections form the primary optical flow information channels, and
wherein the primary visual feature information also comprises optical flow information.

14. A brain-like visual neural network with forward-learning and meta-learning functions according to claim 1, wherein the composite feature encoding module further comprises a plurality of position encoding units,
wherein the neurons comprise position encoding neurons,
wherein the position encoding units comprise a plurality of the position encoding neurons for encoding position information,
wherein each of the position encoding units respectively corresponds to a plurality of subspaces in the image space, and each subspace can have an intersection,
wherein each position encoding neuron respectively corresponds to each region corresponding to said each position encoding neuron's position in each subspace corresponding to the position encoding unit, and accepts the unidirectional or bidirectional excitatory connections of a plurality of the neurons whose receptive fields are said regions,
wherein a plurality of the position encoding neurons respectively form the unidirectional or bidirectional excitatory connections with a plurality of other position encoding neurons corresponding to same region where the position encoding neurons are located,
wherein a plurality of said position encoding neurons can also form the unidirectional or bidirectional excitatory connections with a plurality of the input-side attention control neurons/the output-side attention control neurons/the concrete feature encoding neurons/the abstract feature encoding neurons located in the composite feature encoding module where said position encoding neurons are located, and
wherein a plurality of the position encoding neurons can also respectively form the unidirectional or bidirectional excitatory connections with a plurality of the input-side attention control neurons/the concrete feature encoding neurons/the abstract feature encoding neurons located in said other composite feature encoding modules.

15. A brain-like visual neural network with forward-learning and meta-learning functions according to claim 10, wherein the information channels further comprise intermediate information channels,
wherein the intermediate information channels comprise intermediate position information channels,
wherein the intermediate position information channels are formed by: through the automatic formation process of the information channel, or through pre-setting the initial connection relationship and the initial parameters, the proportion of total weights of the connections of the position encoding neurons and neurons that encode the position information in the total weights of part or all of the connections of the input-side attention control neurons/the output-side attention control neurons/the concrete feature encoding neurons/the abstract feature encoding neuron of a plurality of the composite feature encoding modules is made to reach or exceed a first pre-set ratio, and connection weights from the position-encoding neurons and the neurons encode the position information are made to be combined in variety of proportions, so that the input-side attention control neurons/the output-side attention control neurons/the concrete feature encoding neurons/the abstract feature encoding neurons respectively have one or more of the receptive fields, respectively encode one or more of the position information, and together with the position encoding neurons form the intermediate position information channels.

16. A brain-like visual neural network with forward-learning and meta-learning functions according to claim 15, wherein the intermediate information channels comprise intermediate visual feature information channels,
wherein the intermediate position information channels are formed by: through the information channel automatic formation process, or through pre-setting the initial connection relationship and the initial parameters, the proportion of total weights of the connections of the neurons that are from the primary information channels in the total weights of part or all of the connections of the input-side attention control neurons/the output-side attention control neurons/the concrete feature encoding neurons/the abstract feature encoding neuron of a plurality of the composite feature encoding modules is made to reach or exceed a second pre-set ratio, and connection weights of each neuron in each region and each position in corresponding image space from the primary information channels and the intermediate information channels are combined in a variety of proportions, so that the input-side attention control neurons/the output-side attention control neurons/the concrete feature encoding neurons/the abstract feature encoding neurons respectively have one or more of the receptive fields, respectively encode one or more kinds of intermediate visual feature information, and together form the intermediate visual feature information channels.

17. A brain-like visual neural network with forward-learning and meta-learning functions according to claim 15, wherein the information channels comprise advanced visual information channels,
wherein the advanced position information channels are formed by: through the information channel automatic formation process, or through pre-setting the initial connection relationship and the initial parameters, the proportion of total weights of the connections of the neurons that are from said intermediate information channels in the total weights of part or all of the connections of the input-side attention control neurons/the output-side attention control neurons/the concrete feature encoding neurons/the abstract feature encoding neuron of a plurality of the composite feature encoding modules is made to reach or exceed a third pre-set ratio, and connection weights of each neuron in each region and each position in corresponding image space from the primary information channels, the intermediate information channels and the advanced information channels are combined in a variety of proportions, so that the input-side attention control neurons/the output-side attention control neurons/the concrete feature encoding neurons/the abstract feature encoding neurons respectively have one or more of the receptive fields, respectively encode one or more kinds of advanced visual feature information, and together form the advanced information channels.

18. A brain-like visual neural network with forward-learning and meta-learning functions according to claim 1, wherein the brain-like visual neural network comprises a forward neural pathway and a reverse neural pathway,
wherein the forward neural pathway and the reverse neural pathway are respectively: a plurality of the primary feature encoding modules/the composite feature encoding modules are cascaded in a first pre-set order, and a first neural pathway composed of a plurality of the neurons cascaded along the first pre-set order is regarded as the forward neural pathway, and a second neural pathway composed of a plurality of the neurons cascaded against the first pre-set order is regarded as the reverse neural pathway,
wherein in each primary feature encoding module/each composite feature encoding module, a plurality of the neurons constituting the forward neural pathway can respectively form the unidirectional or bidirectional excitatory/inhibitory connections with a plurality of the neurons constituting the reverse neural pathway,
wherein directional start process comprises forward start process and reverse start process,
wherein the brain-like visual neural network's working processes comprise a forward start process comprising:
step o1: selecting a plurality of neurons in the forward neural pathway as the vibrating neurons,
step o2: making each of the vibrating neurons generate activation distribution and keep activating a third pre-set period Tfprime,
step o3: making a plurality of the neurons in the reverse neural pathway that receive the excitatory connections of the vibrating neurons receive non-negative input for easier activation,
step o4: making a plurality of the neurons in the reverse neural pathway that receive the inhibitory connections of the vibrating neurons receive non-positive input to reduce possibility of activation,
wherein the reverse start process comprises:
step n1: selecting a plurality of neurons in the forward neural pathway as the vibrating neurons,
step n2: making each of the vibrating neurons generate activation distribution and keep activating a tenth pre-set period Tbprime,
step n3: making a plurality of the neurons in the forward neural pathway that receive the excitatory connections of the vibrating neurons receive non-negative input for easier activation,
step n4: making a plurality of the neurons in the forward neural pathway that receive the inhibitory connections of the vibrating neurons receive non-positive input to reduce possibility of activation.

19. A brain-like visual neural network with forward-learning and meta-learning functions according to claim 1, wherein the neurons further comprise interneurons,
wherein the primary feature encoding module and the composite feature encoding module respectively comprise a plurality of the interneurons, wherein unidirectional inhibitory connections are formed with a plurality of corresponding neurons in a corresponding module, and a corresponding number of neurons in each module forms unidirectional excitatory connections with a plurality of corresponding interneurons.

20. A brain-like visual neural network with forward-learning and meta-learning functions according to claim 8, wherein the neurons further comprise a differential information decoupling neuron, and the working process of the brain-like visual neural network also comprises differential information decoupling process,
wherein the differential information decoupling process is:
selecting a plurality of input-side attention control neurons/the output-side attention control neurons/the concrete feature encoding neurons/the abstract feature encoding neurons as target neurons,
selecting a plurality of the neurons with unidirectional/bidirectional excitatory connections with the target neurons as concrete information source neurons, selecting a plurality of other neurons with unidirectional/bidirectional excitatory connections with the target neurons as abstract information source neurons,
wherein each of the concrete information source neurons has a plurality of matched differential information decoupling neurons, wherein each of the concrete information source neurons and each matched differential information decoupling neuron respectively form unidirectional excitatory connections,
wherein the information decoupling neurons respectively with input neurons form unidirectional inhibitory connections with the information source input neurons, or form unidirectional inhibitory synapse-synaptic connections with connections input from the information source neurons to the target neurons, so as to make signal input from the concrete information source neurons to the target neurons to be subject to inhibitory regulation by the matched differential information decoupling neurons, wherein the abstract information source neurons and the differential information decoupling neurons form the unidirectional excitatory connections,
wherein each differential information decoupling neuron can have a decoupled control signal input terminal, wherein degree of information decoupling is adjusted by adjusting magnitude of the signal applied on decoupling control signal input.

21. A brain-like visual neural network with forward-learning and meta-learning functions according to claim 3, wherein forward-learning process comprises:
step a1: selecting a plurality of the neurons as the vibrating neurons,
step a2: selecting a plurality of the neurons as the target neurons,
step a3: adjusting the weights of the unidirectional excitatory connections between one or more of the target neurons and each activated vibrating neuron through the synaptic plasticity process, and
step a4: allowing each activated target neuron to establish the unidirectional or bidirectional excitatory connections with one or more of the other target neurons, or establish self-circulating excitatory connections with itself, adjusting the weight of the unidirectional or bidirectional excitatory connections or the self-circulating excitatory connections through the synaptic plasticity process,
wherein when adjusting the weights of each connection between each target neuron through the synaptic plasticity process, the weights of part or all of the input/output connections can or cannot be standardized.

22. A brain-like visual neural network with forward-learning and meta-learning functions according claim 3, wherein the memory triggering process comprises: inputting information or directly activating a plurality of the neurons in the brain-like visual neural network, or allowing a plurality of the neurons in the brain-like visual neural network to be self-excited, or propagating existing activation states of a plurality of the neurons in the neural network, if a plurality of the neurons in the target area are activated in a second pre-set period, representation of each neuron fired in the target area can be used together with the activation intensity of each neuron fired in the target area as the result or the firing rate of each neuron fired in the target area as a result of the memory triggering process.
wherein the target area can be any sub-network in the neural network.

23. A brain-like visual neural network with forward-learning and meta-learning functions according to claim 3, wherein the information aggregation process comprises:
step g1: selecting one or more of the neurons as the vibrating neurons,
step g2: selecting one or more of the neurons as source neurons,
step g3: selecting one or more of the neurons as the target neurons,
step g4: making each of the vibrating neurons generate activation distribution and maintain activation of eighth pre-set period Tk,
step g5: during the eighth pre-set period Tk, adjusting the weights of the unidirectional or bidirectional excitatory/inhibitory connections between each activated vibrating neuron and a plurality of the target neurons through the synaptic plasticity process,
step g6: during the eighth pre-set period Tk, adjusting the weights of the unidirectional or bidirectional excitatory/inhibitory connections between each activated source neuron and a plurality of the target neurons through the synaptic plasticity process, and
step g7: performing one or more iterations, wherein each time the step g1 to the step g6 is processed is denoted as one iteration,
wherein one or more of the target neurons are mapped to corresponding tags as a result of the information aggregation process of the memory module.

24. A brain-like visual neural network with forward-learning and meta-learning functions according to claim 3, wherein the directional information aggregation process of the memory module comprises:
step h1: selecting a plurality of the information input neurons as the vibrating neurons,
step h2: selecting a plurality of the memory neurons as the source neurons,
step h3: selecting a plurality of the memory neurons as the target neurons,
step h4: making each of the vibrating neurons generate activation distribution and maintaining activation of ninth pre-set period Ta,
step h5: during the ninth pre-set period Ta, activating Ma1 of the source neurons and Ma2 of the target neurons,
step h6: during the ninth pre-set period Ta, recording first Ka1 source neuron with the highest activation intensity or the highest firing rate or the first to be excited as Ga1, and recording remaining Ma1-Ka1 activated source neurons as Ga2,
step h7: during the ninth pre-set period Ta, recording the first Ka2 target neurons with the highest activation intensity or the highest firing rate or the first to be excited as Ga3, and recording remaining Ma2-Ka2 activated target neurons as Ga4,
step h8: during the ninth pre-set period Ta, allowing each source neuron in the Ga1 and the unidirectional or bidirectional excitatory/inhibitory connections between a plurality of the target neurons in the Ga3 to perform one or more synaptic weights enhancement processes,
step h9: during the ninth pre-set period Ta, allowing the unidirectional or bidirectional excitatory/inhibitory connections between each source neuron in the Ga1 and a plurality of the target neurons in the Ga4 to perform one or more synaptic weights reduction processes,
step h10: during the ninth pre-set period Ta, allowing each source neuron in the Ga2 and the unidirectional or bidirectional excitatory/inhibitory connections between a plurality of the target neurons in the Ga3 to perform or not to perform once or more times of the synaptic weights reduction processes,
step h11: during the ninth pre-set period Ta, allowing each source neuron in the Ga2 and the unidirectional or bidirectional excitatory/inhibitory connections between a plurality of the target neurons in the Ga4 to perform or not to perform one or more synaptic weights enhancement processes,
step h12: during the ninth pre-set period Ta, allowing each activated vibrating neuron and the unidirectional excitatory/inhibitory connections between the target neurons in the Ga3 to perform once or more times of the synaptic weights enhancement processes,
step h13: during the ninth pre-set period Ta, allowing each activated vibrating neuron and the unidirectional excitatory/inhibitory connections between a plurality of the target neurons in the Ga4 to perform once or more times of the synaptic weights reduction processes, and
step h14: performing one or more iterations, wherein each time the step h1 to the step h13 is performed is denoted as one iteration,
wherein in the process from the step h8 to the step h13, after once or more times of the synaptic weights enhancement processes or the synaptic weights reduction processes are performed, the weights of the input connections or the output connections of part or all of the source neurons or of the target neurons can be standardized or not standardized,
wherein the synaptic weights enhancement processes can adopt a unipolar upstream/downstream activation dependent synaptic enhancement process, or a unipolar spiking time dependent synaptic enhancement process,
wherein the synaptic weights reduction processes can adopt a unipolar upstream/downstream activation dependent synaptic reduction process, or a unipolar spiking time dependent synaptic reduction process,
wherein the synaptic weights enhancement process and the synaptic weights reduction process can also adopt the asymmetric bipolar spiking time dependent synaptic plasticity process or the symmetric bipolar spiking time dependent synaptic plasticity process,
wherein the Ma1 and Ma2 are positive integers, Ka1 is a positive integer not exceeding Ma1, and Ka2 is a positive integer not exceeding Ma2.

25. A brain-like visual neural network with forward-learning and meta-learning functions according to claim 3, wherein the information transcription process comprises:
step f1: selecting a plurality of the neurons as the vibrating neuron,
step f2: selecting a plurality of direct downstream neurons or indirect downstream neurons of the vibrating neurons as the source neurons,
step f3: selecting a plurality of the direct downstream neurons or the indirect downstream neurons of the vibrating neurons as the target neurons,
step f4: making each of the vibrating neurons generate activation distribution and maintain activation for seventh pre-set period Tj,
step f5: during the seventh pre-set period Tj, activating a plurality of the source neurons,
step f6: during the seventh predetermined period Tj, if a certain vibrating neuron is the direct upstream neuron of a certain target neuron, adjusting the weights of the unidirectional or bidirectional excitatory/inhibitory connections between the certain vibrating neuron and the certain target neuron through the synaptic plasticity process, if the certain vibrating neuron is the indirect upstream neuron of a certain target neuron, adjusting unidirectional or bidirectional excitatory/inhibitory connections between the direct upstream neuron of the target neuron and the target neuron in the connections pathway between the certain vibrating neuron and the certain target neuron through the synaptic plasticity process,
step f7: during the seventh pre-set period Tj, if each of the target neurons can establish connections with several other target neurons, adjusting the weights through the synaptic plasticity process, and
step f8: during the seventh pre-set cycle Tj, if there are the unidirectional or bidirectional excitatory connections between a certain source neuron and the certain target neuron, adjusting the weights through the synaptic plasticity process.

26. A brain-like visual neural network with forward-learning and meta-learning functions according to claim 3, wherein the memory forgetting process comprises an upstream distribution dependent memory forgetting process, a downstream distribution dependent memory forgetting process, and an upstream and downstream distribution dependent memory forgetting process,
wherein the upstream distribution dependent memory forgetting process comprises: for a certain connection, if its upstream neuron continues to not distribute within fourth pre-set period, absolute value of the weights is reduced, and the reduced amount is denoted as DwDecay1,
wherein the downstream distribution dependent memory forgetting process comprises: for the certain connection, if its downstream neuron continues to not distribute within fifth pre-set period, the absolute value of the weights is reduced, and the reduced amount is denoted as DwDecay2,
wherein the upstream and downstream distribution dependent memory forgetting process comprises: for the certain connection, if its upstream and downstream neurons do not perform synchronous distribution during sixth pre-set period, the absolute value of the weights is reduced, and the reduced amount is denoted as DwDecay3,
wherein the synchronous distribution comprises: when the downstream neuron involved in the connections activates, and time interval from current or past most recent upstream neuron activation does not exceed fourth pre-set time interval Te1, or when the upstream neuron involved in the connections activates, and the time interval from the current or past most recent downstream neuron activation does not exceed the fifth pre-set time interval Te2,
wherein in the memory forgetting process, if the certain connection has a specified lower limit of the absolute value of the weights, the absolute value of the weights will no longer decrease when the absolute value of the weights reaches the lower limit, or the connections will be cut off.

27. A brain-like visual neural network with forward-learning and meta-learning functions according to claim 3, wherein the memory self-consolidation process comprises: when a certain neuron is self-excited, the weights of part or all of the certain neuron is adjusted through a unipolar downstream activation dependent synaptic enhancement process and a unipolar downstream spiking dependent synaptic enhancement process, wherein the weights of part or all of output connections of the certain neuron are adjusted through a unipolar upstream activation dependent synaptic enhancement process and a unipolar upstream spiking dependent synaptic enhancement process.

28. A brain-like visual neural network with forward-learning and meta-learning functions according to claim 3, wherein the information component adjustment process of the brain-like neural network comprises:
step i1: selecting a plurality of the neurons as the vibrating neurons,
step i2: selecting a plurality of direct downstream neurons or indirect downstream neurons of the vibrating neurons as the target neurons,
step i3: making each of the vibrating neurons generate activation distribution, and maintaining activation of each vibrating neuron during first pre-set period Tb,
step i4: during the first pre-set period Tb, activating Mb1 of the target neurons, wherein first Kb1 target neurons with the highest activation intensity or the highest firing rate or the first to be excited are recorded as Gb1, and remaining Mb1-Kb1 activated target neurons are recorded as Gb2,
step i5: if a certain vibrating neuron is a direct upstream neuron of a certain target neuron in the Gb1, making the unidirectional or bidirectional connections between the certain vibrating neuron and the certain target neuron to perform one or more synaptic weights enhancement processes, and if the certain vibrating neuron is an indirect upstream neuron of the certain target neuron in the Gb1, then making the unidirectional or bidirectional connections, which are between the certain target neuron and the direct upstream neuron of said certain target neuron, in the connections paths between the certain vibrating neuron and the certain target neuron to perform once of more times of the synaptic weights enhancement processes,
step i6: if the certain vibrating neuron is the direct upstream neuron of the certain target neuron in the Gb2, making the unidirectional or bidirectional connections between the certain vibrating neuron and the certain target neuron perform once or more times of the synaptic weights reduction processes, and if the vibrating neuron is the indirect upstream neuron of the certain target neuron in the Gb2, then making the unidirectional or bidirectional connections, which are between the certain target neuron and the direct upstream neuron of said certain target, in the connections paths between the certain vibrating neuron and the certain target neuron perform once or more times of the synaptic weights reduction processes, and
step i7: performing one or more iterations, wherein each time that the step i1 to the step i6 is performed is denoted as one iteration,
wherein in the process of the step i5 and the step i6, after performing once or more times of the synaptic weights enhancement processes or the synaptic weights reduction processes, the weights of part or all of the input connections of each target neuron can be standardized or not,
wherein the synaptic weights enhancement processes can adopt a unipolar upstream/downstream activation dependent synaptic enhancement process, or a unipolar spiking time dependent synaptic enhancement process,
wherein the synaptic weights reduction processes can adopt a unipolar upstream/downstream activation dependent synaptic reduction process, or a unipolar spiking time dependent synaptic reduction process,
wherein the synaptic weights enhancement process and the synaptic weights reduction process can also adopt the asymmetric bipolar spiking time dependent synaptic plasticity process or the symmetric bipolar spiking time dependent synaptic plasticity process.

29. A brain-like visual neural network with forward-learning and meta-learning functions according to claim 3, wherein the reinforcement learning process comprises: when a plurality of the connections receive a reinforcement signal, in the second pre-set potential, the weights of the connections change, or the weights reduction of connections changes, or the weights increase/reduction of the connections in the synaptic plasticity process changes, or
when one or more of the neurons receive the reinforcement signal, in the third pre-set potential, the neurons receive positive or negative input, or the weights of part or all of the input connections or output connections of these neurons change, or the weights reduction of the connections in the memory forgetting process changes, or the weights increase/reduction of the connections in the synaptic plasticity process change.
wherein the reinforcement signal is a constant value when the brain-like visual neural network has no input information, wherein in the supervised learning process, if the result of the memory triggering process is correct, the reinforcement signal rises, if the result of the memory triggering process is wrong, then the reinforcement signal drops.

30. A brain-like visual neural network with forward-learning and meta-learning functions according to claim 3, wherein the novelty signal modulation process comprises: when a plurality of the neurons receive the novelty signal, in sixth pre-set time interval, said plurality of the neurons receive positive or negative input, or the weights of part or all of input connections or output connections of said plurality of the neurons change, or the weights reduction of the connections in the memory forgetting process change, or the weight increase/reduction of the connections in the synaptic plasticity process change,
wherein when the brain-like visual neural network has no input information, the novelty signal is a constant value or gradually decreases with time, wherein when the brain-like visual neural network has input information, the novelty signal is negatively correlated with the activation intensity or firing rate of each neuron in the target region during the memory triggering process.

31. A brain-like visual neural network with forward-learning and meta-learning functions according to claim 3, wherein the supervised learning process comprises:
step r1: giving positive activation distribution range of each neuron in the target area, giving negative activation distribution range of each neuron in the target area, and then performing step r2,
step r2: performing the memory triggering process, if actual activation distribution of each neuron in the target area does not conform to the positive activation distribution range or the negative activation distribution range, it is regarded as each neuron in the target area does not encode relevant memory information, and performing step R3, if the actual distribution of each neuron in the target area conforms to the positive distribution range, the result of the memory triggering process is regarded as correct, and the supervised learning process is ended, if the actual release distribution of each neuron in the target area conforms to the negative activation distribution range, the result of the memory triggering process is regarded as an error, and performing step r3,
step r3: performing one or more of the novelty signal modulation process, the reinforcement learning process, the active attention process, the automatic attention process, the directional start process, the forward-learning process, the information aggregation process, the directional information aggregation process, the information component adjustment process, the information transcription process and the differential information decoupling process, so that each neuron in the target area encodes the relevant memory information, and performing step r1,
wherein the supervised learning process can also comprise:
step q1: giving positive label range, and giving negative label range, and performing q2,
step q2: performing the memory triggering process, and mapping the actual activation distribution of each neuron in the target area to corresponding label, if the corresponding label does not meet the positive label range nor the negative label range, it is regarded as each neuron in the target area does not encode the relevant memory information, then perming step q3, if the corresponding label meets the positive label range, the result of the memory triggering process is deemed correct, and the supervised learning process is ended, if the corresponding label meets the negative label range, the result of the memory triggering process is regarded as an error, and then performing step q3,
step q3: performing one or more of the novelty signal modulation process, the reinforcement learning process, the active attention process, the automatic attention process, the directional start process, the forward-learning process, the information aggregation process, the directional information aggregation process, the information component adjustment process, and the information transcription process and the differential information decoupling process, so that each neuron in the target area encodes relevant memory information, and then performing the step q1.

32. A brain-like visual neural network with forward-learning and meta-learning functions according to claim 4, wherein the unipolar upstream activation dependent synaptic plasticity process comprises a unipolar upstream activation dependent synaptic enhancement process and a unipolar upstream activation dependent synaptic reduction process,
wherein the unipolar upstream activation dependent synaptic enhancement process comprises: when the activation intensity or firing rate of the upstream neurons involved in the connections is not zero, the absolute value of weights of the connections will be increased, and the increment is denoted as DwLTP1u,
wherein the unipolar upstream activation dependent synaptic reduction process comprises: when the activation intensity or firing rate of the upstream neurons involved in the connections is not zero, the absolute value of the weights of the connections will be reduced, the reduction is denoted as DwLTD1u, and
wherein DwLTP1u and DwLTD1u are non-negative values.

33. A brain-like visual neural network with forward-learning and meta-learning functions according to claim 4, wherein the unipolar downstream activation dependent synaptic plasticity process comprises a unipolar downstream activation dependent synaptic enhancement process and a unipolar downstream activation dependent synaptic reduction process,
wherein the unipolar downstream activation dependent synaptic enhancement process comprises: when the activation intensity or firing rate of the downstream neurons involved in the connections is not zero, the absolute value of weights of the connections is increased, and the increment is denoted as DwLTP1d,
wherein the unipolar downstream activation dependent synaptic reduction process comprises: when the activation intensity or firing rate of the downstream neurons involved in the connections is not zero, the absolute value of the weights of the connections will be reduced, the reduction is denoted as DwLTD1d, and
wherein DwLTP1d and DwLTD1d are non-negative values.

34. A brain-like visual neural network with forward-learning and meta-learning functions according to claim 4, wherein the unipolar upstream and downstream activation dependent synaptic plasticity process comprises a unipolar upstream and downstream activation dependent synaptic enhancement process and a unipolar upstream and downstream activation dependent synaptic reduction process,
wherein the unipolar upstream and downstream activation dependent synaptic enhancement process comprises: when the activation intensity or firing rate of the upstream and downstream neurons involved in the connections is not zero, the absolute value of weights of the connections will be increased, and the increment is denoted as DwLTP2,
wherein the unipolar upstream and downstream activation dependent synaptic reduction process comprises: when the activation intensity or firing rate of the upstream and downstream neurons involved in the connections is not zero, the absolute value of the weights of the connections will be reduced, the reduction is denoted as DwLTD2, and
wherein DwLTP2 and DwLTD2 are non-negative values.

35. A brain-like visual neural network with forward-learning and meta-learning functions according to claim 4, wherein the unipolar upstream spiking dependent synaptic plasticity process comprises a unipolar upstream spiking dependent synaptic enhancement process and a unipolar upstream spiking dependent synaptic reduction process,
wherein the unipolar upstream spiking dependent synaptic enhancement process comprises: when the upstream neurons involved in the connections activates, the absolute value of weights of the connections will be increased, and the increment is denoted as DwLTP3u,
wherein the unipolar upstream spiking dependent synaptic reduction process comprises:
when the upstream neurons involved in the connections activates, the absolute value of the weights of the connections will be reduced, the reduction is denoted as DwLTD3u, and
wherein DwLTP3u and DwLTD3u are non-negative values.

36. A brain-like visual neural network with forward-learning and meta-learning functions according to claim 4, wherein the unipolar downstream spiking dependent synaptic plasticity process comprises a unipolar downstream spiking dependent synaptic enhancement process and a unipolar downstream spiking dependent synaptic reduction process,
wherein the unipolar upstream spiking dependent synaptic enhancement process comprises: when the upstream neurons involved in the connections activates, the absolute value of weights of the connections will be increased, and the increment is denoted as DwLTP3d,
wherein the unipolar upstream spiking dependent synaptic reduction process comprises: when the upstream neurons involved in the connections activates, the absolute value of the weights of the connections will be reduced, the reduction is denoted as DwLTD3d, and
wherein DwLTP3d and DwLTD3d are non-negative values.

37. A brain-like visual neural network with forward-learning and meta-learning functions according to claim 4, wherein the unipolar spiking time dependent synaptic plasticity process comprises a unipolar spiking time dependent synaptic enhancement process and unipolar spiking time dependent synaptic reduction process,
wherein the unipolar spiking time dependent synaptic enhancement process comprises: when the upstream neurons involved in the connections activates, and the time interval from the current or past most recent upstream neurons firing is no more than Tg1, or when the downstream neurons involved in the connections activates, the time interval from the current or past most recent downstream neuron firing is no more than Tg2, the absolute value of weights of the connections will be increased, and the increment is denoted as DwLTP4,
wherein the unipolar spiking time dependent synaptic reduction process comprises: when the downstream neurons involved in the connections activates, and the time interval from the current or past most recent downstream neurons firing is no more than Tg3, or when the downstream neurons involved in the connections activates, the time interval from the current or past most recent downstream neuron firing is no more than Tg4, the absolute value of the weights of the connections will be reduced, the reduction is denoted as DwLTD4, and
wherein DwLTP4 and DwLTD4 are non-negative values.

38. A brain-like visual neural network with forward-learning and meta-learning functions according to claim 4, wherein the asymmetric bipolar spiking time dependent synaptic plasticity process comprises:
when the downstream neurons involved in the connections activates, if the time interval from the current or past most recent downstream neurons firing is no more than Th1, the absolute value of the weights will be increased, and the increment is denoted as DwLTP5, if the time interval from the current or past most recent upstream neurons firing is more than Th1 but is no more than Th2, the absolute value of the weights of the connections will be reduced, the reduction is denoted as DwLTD5, or
when the upstream neurons involved in the connections activates, if the time interval from the current or past most recent upstream neurons firing is no more than Th3, then the absolute value of the weights will be increased, and the increment is denoted as DwLTP5, if the time interval from the current or past most recent downstream neurons firing is more than Th3 but is no more than Th4, the absolute value of the weights of the connections will be reduced, the reduction is denoted as DwLTD5, and
wherein Th1, Th3, DwLTP5 and DwLTD5 are non-negative, Th2 is a value greater than Th1, and Th4 is a value greater than Th3.

39. A brain-like visual neural network with forward-learning and meta-learning functions according to claim 4, wherein the symmetric bipolar spiking time dependent synaptic plasticity process comprises:
when the downstream neurons involved in the connections activates, if the time interval from the current or past most recent downstream neurons firing is no more than Ti1, the absolute value of the weights of the connections will be increased the increase is denoted as DwLTP6,
if the time interval from the current or past most recent downstream neurons firing is more than Th1 but is no more than Ti2, the absolute value of the weights of the connections will be reduced, the reduction is denoted as DwLTD6, wherein Th1, Th2, DwLTP6 and DwLTD6 are non-negative.
